(19) United States
(12) Patent Application Publication
(10) Pub. No.: US 2012/0256929 A1
(43) Pub. Date: Oct. 11, 2012

(54) EXPANDABLE MULTI-CORE TELECOMMUNICATION AND VIDEO PROCESSING APPARATUS

(76) Inventors: Eric Koenig, Huntington, NY (US); Steven P. Apelman, Centereach, NY (US)

(21) Appl. No.: 13/084,539

(22) Filed: Apr. 11, 2011

Related U.S. Application Data
(60) Provisional application No. 61/474,218, filed on Apr. 11, 2011.

(51) Int. Cl. G06F 15/163

(52) U.S. Cl. 345/503

(57) ABSTRACT

An expandable multi-core telecommunication and video processing apparatus includes a primary wireless telecommunications device having a microprocessor that can be programed for running a wide range of software application and includes a primary, or main, viewer touch screen interface and a plurality of ports for receiving one or more video core processors. Each video core processor is removably connectable to a port located along a surface of the primary telecommunications device for permitting a plurality of individual videos which can be interfaced by a user. The individual videos displaced by each connected video core processor can act in concert with, or independently of, the main, or primary, touch screen interface which is located on a front surface of the primary telecommunications device. The primary telecommunications device further includes a detachable storage bay for retaining video core processors when not connected with the primary telecommunications device. The primary telecommunications device and the video core processors are, preferably, each connectable to a docking station, which can download data from either a video core processor or the primary telecommunications device. The docking station can be connected to a personal computer.

### CROSS-REFERENCE TO RELATED APPLICATION

The inventors claim domestic priority, pursuant to 35 U.S.C. §119(e), on the basis of U.S. Provisional Patent Application No. 61/474,218, filed Apr. 11, 2011, the entire disclosure of which shall be deemed to be incorporated by reference herein.

### BACKGROUND OF THE INVENTION

1. Technical Field of the Invention

The present invention relates, generally, to an expandable multi-core telecommunications and video processing apparatus.

More particularly, the present invention relates to a multiple viewing element system capable of simultaneously presenting a plurality of individual video images to a user at any time via additionally deployable, discrete, detachable and reconnectable video core processors. The video core processors are connectable to a primary wireless telecommunications device having a microprocessor and operable as what is commonly known, or referred to as a “smart phone,” and which may also be viewed as a hand-held or mobile personal computer. There may be, and preferably would be, as many as five individual video images that may be presented to the user at any given time using multiple video core processors connected to the primary wireless hand-held telecommunications or personal computing device. A varying number of individual video images are possible and within the scope of the present invention and, as such, reference to a particular number of such video core processors should be viewed as a preference, rather than a requirement of the present invention, with all such variable number of video core processors being within the scope of the presently claimed invention.

The art video processing displays, or video core processors, are utilized as part of the present invention, in combination with the primary wireless telecommunications or computer device, which includes a viewer touch screen interface, which allows the user the option of viewing, storing, recalling and acting upon any, or all, of the connected screen of video content.

The present invention further includes, as a preferred embodiment, a docking station, which is connectable to a USB port of the primary telecommunications and computing device and to a USB port of a personal computer. The docking station is further able to interface with each video core processor for permitting the uploading or downloading of data and other types of files, including application programs, to, and from, any video core processor, as well as to and from the primary device.

2. Description of the Prior Art

The prior art includes mobile devices having auxiliary display screens, as well as multi-fold display surface devices. Among the most relevant prior art known to the inventors is Miyashita et al., U.S. Pat. No. 6,327,482 B1, issued Dec. 4, 2001, which discloses a mobile radio apparatus with additional display devices that includes a connector portion which allows for the additional display devices to be removably connected to the side of a primary apparatus, such as a mobile radio device. Similarly, Sall, U.S. Pat. No. 6,859,219 B1, issued Feb. 22, 2005, discloses an apparatus and related method having multiple display devices that are stored within a primary mobile device and withdrawn therefrom by a user, as desired.

Both Miyashita et al. and Sall teach the use of additional display devices, however, neither prior art reference teaches, suggests nor otherwise pertains to allowing for the use of removably connectable video core processors via USB ports to a primary mobile telecommunications/computer device, which video core processors can operate in combination with another and the primary mobile device for accomplishing far more complex tasks than simply displaying of one or more images.

Koenig, U.S. Pat. No. 7,138,962 B2, issued Nov. 21, 2006, discloses a wireless telecommunications device having a primary screen and one or more additional display screens that are either hinged, nested or housed within the telecommunications device, but does not disclosure the use of connectable video core processors in combination with a wireless telecommunication device having capabilities of those analogous to a smart phone or personalized, hand-held computing device.

Kilpatrick, Il et al., U.S. Patent Application Publication No. 2010/0064244 A1, published Mar. 11, 2010, discloses a mobile device having a foldable display device, which, in like fashion to Miyashita et al., Sall and Koenig, fails to provide for the use of video core processors that can be added to a primary mobile device and readily manipulated when attached.

The prior art fails to teach or suggest a multi-video processing data stacking device that may, for example, allow for multiple video core processors and viewing elements, which can be manipulated by the user for performing various programmed functions, rather than merely enlarging the area of a display included with a primary device.

### SUMMARY OF THE INVENTION

It is, therefore, an object of the present invention to provide an expandable multi-core telecommunications and video processing apparatus that is capable of simultaneously presenting a plurality of individual video images to a user at any time via additionally deployable, discrete, detachable and reconnectable video core processors.

It is a further object of the present invention to provide an expandable multi-core telecommunications and video processing apparatus, which includes a docking station that is able to interface with one or more video core processors connectable to a primary wireless device for permitting the uploading or downloading of data and other types of files, including application programs, to, and from, any video core processor, as well as to and from the primary wireless telecommunications or similar hand-held computer device.

It is an additional object of the present invention to provide an expandable multi-core telecommunications and video processing apparatus which includes a detachable storage bay for a plurality of video core processors, preferably located along a back surface of the primary wireless telecommunications or hand-held computer when such video core processors are not in use.

The foregoing and related objects are accomplished by the expandable multi-core telecommunications and video processing apparatus of the present invention, which includes a primary wireless telecommunications device having a microprocessor that is programmable for running a wide range of software application and includes a primary, or main, viewer touch screen interface and a plurality of ports for receiving one or more video core processors (“VCP.”) Each VCP is removably connectable to a port located along a surface of the primary telecommunications device, thereby permitting a plurality of individual videos which can be interfaced by a user. The individual videos displaced by each connected VCP can act in concert with, or independently of, the main, or primary, touch screen interface which is centrally located on a front surface of the primary telecommunications device.

The primary telecommunications device is further provided with a storage bay having a plurality of slots, preferably contiguous with a rear surface of the primary device for storage some or all of the VCP units connectable to the primary device. The outer surface of the storage bay, in a particularly preferred embodiment, includes means for assisting the user in securely holding the entirety of the primary telecommunications device with the storage bay for the VCP devices. Such means are preferably, but not limited to, a multi-finger slot, such as a slot for the user's index finger and middle finger.

In a preferred embodiment, the present invention further comprises a docking station and a USB interface link, and may have the ability of allowing video information to be uploaded and stored within the discrete and removable video core processors via a personal computer with the same docking station and USB interface link. For speed and efficiency, the docking station directly interfaces with the discrete detachable plug-in VCP and viewing element modules and the personal computer via a USB port and, preferably, not via the primary telecommunications device's CPU because of the volume and transfer rates of the data to be processed. By having each of the discrete detachable plug-in video processor and viewing element modules being virtually its own core processor, and its own de facto independent computer, each such unit is capable of directly addressing a personal computer and directly transferring data at high speed straight to the on-board flash memory.

Due to the USB interface to a personal through the docking station of the present invention, current standard FireWire cable speeds of 100 MBPS can easily be reached, making the uploading or downloading of very large quantities of data exceptionally quick; a rate virtually impossible to achieve by using a lesser design strategy whereby the single mainframe CPU would control data throughput, thereby rendering the primary telecommunications device of the present invention a particularly useful and efficient one. The user has, at any time, the option of selecting, however, many additional video processor cores he or she wishes to activate by inserting one or more VCPs into any of the four accessory connectors provided under protective covers that are preferably accessible on the four sides of the periphery of the primary telecommunications device.

For full feature operation at its optimal speed, a specialized server application will be required that formulates the custom composite data content (“CDC”) stream transmitted by a service provider that will encode all the audio, video and control signals for direct operations. It will be understood by those skilled in the art that a CDC stream is a continuous transmission of voice, video and control signals mixed together, so that one transmitted RF carrier signal can, and would be expected, to contain all such signals. Without a custom CDC stream, conventional software applications will be required to generate the desired data, creating time delays that will result in slowing down the overall system performance, nevertheless, the presently claimed invention would still accomplish all desired tasks.

A specific terminate-stay-ready (“TSR”) application will be running within the primary telecommunications device of the mainframe operating system of the present invention and will be interactive with the number of detachable video core processors and viewing elements that have been deployed by the user. If, for example, the user desires that only one additional VCP be deployed, the microprocessor will be prompted by sensors that there are only two video images available; the main, or primary, screen of the primary telecommunications device, which is always available and a single additional video processor that is deployed. It will be understood that a TSR application is a particular type of program subroutine that runs in the background of a larger, more primary or direct, computer program. The TSR program executes its function, terminates and then goes into a “sleep” mode until called upon again by the primary or main operating system. The TSR application remains in the random access memory (“RAM”) within the personal computer waiting to be activated, or called back in operating or active mode, as and when required.

All the other video information sent through the CDC stream will be archived in the video cache for retrieval at another point in time or by selection to the currently attached video processor. The TSR program that allows the video information that is not presently being displayed to be stored will also have the capacity to prompt the viewer on the main screen as to the level of importance of the cached video signals. If the user then decides that the non-displayed information is more important than the currently viewed data, the video processor viewer content can be exchanged with the currently available video processor read-out. This feature allows the user, although not viewing all the available video data at that instant, to never be completely cut off from any of the additional stored images, and always be informed as to the importance of them at any instant of time.

The primary telecommunications device of the present invention has a platform that incorporates an audio processing channel for the purpose of frequency discrimination and identification. A fast Fourier transform network exists in the audio processing channel so that the frequency content of microphone signals can be analyzed. The fast Fourier network will allow the computer of the primary device to access specific frequencies of a detected sound. The primary telecommunications device further provides for a software application whereby detectable encoded sequences can activate a call-forward scheme to inform the service provider network the location of the primary telecommunications device for the purpose of subsequently downloading pertinent information advantageous to the user with respect to the location of the primary device of the present invention.

Other objects and features of the present invention will become apparent when considered in combination with the accompanying drawing figures which illustrate certain preferred embodiments of the present invention. It should, however, be noted that the accompanying drawing figures are intended to illustrate only certain embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 is a generalized side view of the primary telecommunications device of the present invention showing a storage bay for retaining a plurality of video core processors;

FIG. 2 is a generalized prospective rear view of the primary telecommunications device of the present invention showing slots for receiving a plurality of removably connectable video core processors and the storage bay therefor;

FIG. 3 is a generalized prospective front view of the primary telecommunications device of the present invention showing a plurality of video core processors and where each of four video core processors would be removably connectable to primary telecommunications device;

FIG. 4 is a generalized schematic view of the primary telecommunications device as being connectable via a USB port and cable connection to a docking station, which is able to receive a video core processor via a USB port, and which docking station is itself connectable to a personal computer via a further USB port;

FIG. 5 is a detailed plan view of the primary telecommunications device of the present showing four video core processors connected thereto;

FIG. 6 is a detailed side view of the primary telecommunications device of FIG. 5, which shows in phantom a possible position for a rotating finger bracket for allowing a user to more securely hold the present invention;

FIG. 7 is a detailed bottom view of the primary telecommunications device of FIG. 5;

FIG. 8 is a detailed top view of the primary telecommunications device of FIG. 5;

FIG. 9 is a detailed back view of a portion of the primary telecommunications device of the present invention showing the rotating finger bracket thereof and manner of possible rotation;

FIG. 10 is a detailed exploded perspective view of a preferred embodiment of the primary telecommunications device of the present invention;

FIG. 10A is a plan view of a preferred embodiment for a video core processor having a barrel hinge with a plug that is connectable to the primary telecommunications device and, as further preferred, with a port located on an opposing edge of the video core processor for receiving the plug of a barrel hinge of an additional video core processor;

FIG. 10B shows the video core processor of FIG. 10A having a barrel hinge prior to being plugged into, or detachably connected, to the primary telecommunications device;

FIG. 10C shows a plurality of video core processors of the preferred embodiment shown in FIG. 10A prior to connection to the primary telecommunications device;

FIG. 10D shows the plurality of video core processor of the preferred embodiment of FIG. 10A and those of FIG. 10C, as connected;

FIG. 10E shows the plurality of connected video core processors of FIG. 10D with the barrel hinges being rotated in certain instances to show flexibility between adjoined video core processors;

FIG. 11 is a detailed expanded bottom view of the primary telecommunications device of the present invention with an enlarged view of a corner of a portion thereof showing greater detail including a sensor for a power supply obtained from battery power;

FIG. 12 is an additional detailed top view of the primary telecommunications device of the present invention showing a plurality of slots for retaining video core processors when not in use;

FIG. 13 is an additional detailed bottom view of the primary telecommunications device of the present invention showing preferred locations for a USB port, main CPU and battery locations within the primary telecommunications device;

FIG. 14 is a bottom detailed view of the primary telecommunications device of the present invention showing a rear access door for accessing the battery supply of the primary telecommunications device in an open position;

FIG. 14A shows a preferred embodiment of one of four possible video core processor connectors as a breakaway point contact style;

FIG. 14B shows a preferred embodiment of the video core processors as being equipped with eight spring-loaded movable points that will make electrical contact when engaged with the connector surface of the primary telecommunications device as shown in FIG. 14A;

FIG. 14C shows a preferred embodiment of the video core processor connector module that can be disconnected, rotated 180°, and replaced onto the same connector module for the display of the particular video core processor to be viewed from the reverse side of the primary telecommunications device;

FIG. 14D shows an enlarged, detailed view of the point contact pin arrangement of FIGS. 14A, 14B and 14C;

FIG. 15 is a circuit diagram of a transceiver dipole antenna employing a diplexer filter for the primary telecommunications device;

FIG. 16 is a circuit diagram of an RF filter being fed with an RF power signal from an RF amplifier for the primary telecommunication device;

FIG. 17 is a circuit diagram of RF power passing through the RF filter stage and through the diplexing filter until it reaching the transmitting antenna of the primary telecommunications device;

FIG. 18 is a circuit diagram showing that the RF LNA is required to boost the very low level signals from the receiving antenna to an appropriate level for processing in the follow-on mixing stage of the primary telecommunications device;

FIG. 19 is a circuit diagram of the local oscillators and mixers of the primary telecommunications device of the present invention;

FIG. 20 is a flow chart for the circuitry of the power management tasks carried out by primary telecommunications device of the present invention;

FIG. 21 is a flow chart for the circuitry of the synch separation required for the extraction of the different components of the composite data content stream;

FIG. 22 is a flow chart for the circuitry of the video data stream and retrieved decoder signals needed to interpret the images processed through the main microprocessor of the primary telecommunications device and feed the circuit combination of the video memory cache that is collecting and coordinating the video and data streams;

FIG. 23 is a flow chart for the circuitry of the audio processing that requires handshake signals from the CPU and the D/A converters that are changing the received digital data into analog patterns, and that of the anti-aliasing filter that strives to keep any unwanted rhythmic harmonic patterns from destroying the integrity of the reconstructed waveform;

FIGS. 24-26 are flow charts for the circuitry for Bluetooth® connectivity that provides users of the primary telecommunications device the ability to use remote Bluetooth® headsets to communicate phone calls, link to a computer, and log into any other Blue-tooth® communications platform as long as the operating software application has been loaded onto the CPU of the primary telecommunications device of the present invention;

FIG. 27 is a flow chart for the circuitry of the system camera module of the primary telecommunications device of the present invention;

FIG. 28 is a flow chart for the circuitry of a video display processor with an associated microcontrol and video camera for the primary telecommunications device of the present invention; and,

FIG. 29 is a flow chart for the circuitry of a video display processor with an associated microcontrol for the primary telecommunications device of the present invention.

### DETAILED DESCRIPTION OF THE DRAWING FIGURES AND PREFERRED EMBODIMENTS

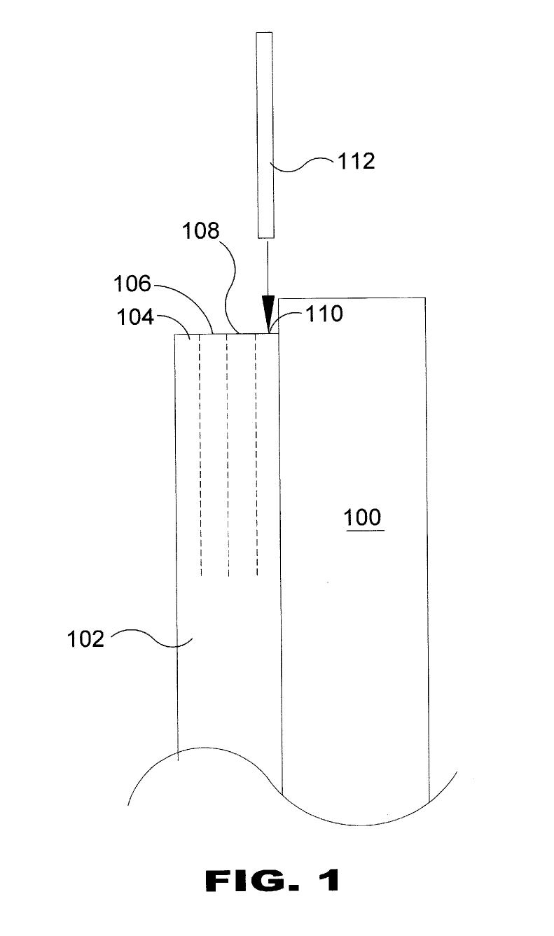

Turning now, in detail, to the drawing figures, FIG. 1 is a generalized side view of the primary telecommunications device 100 having a detachable storage bay 102, located on a rear surface of the primary telecommunications device, with a plurality of slots 104, 106, 108, 110, each for retaining a video core processor (“VCP”) 112 when not in use.

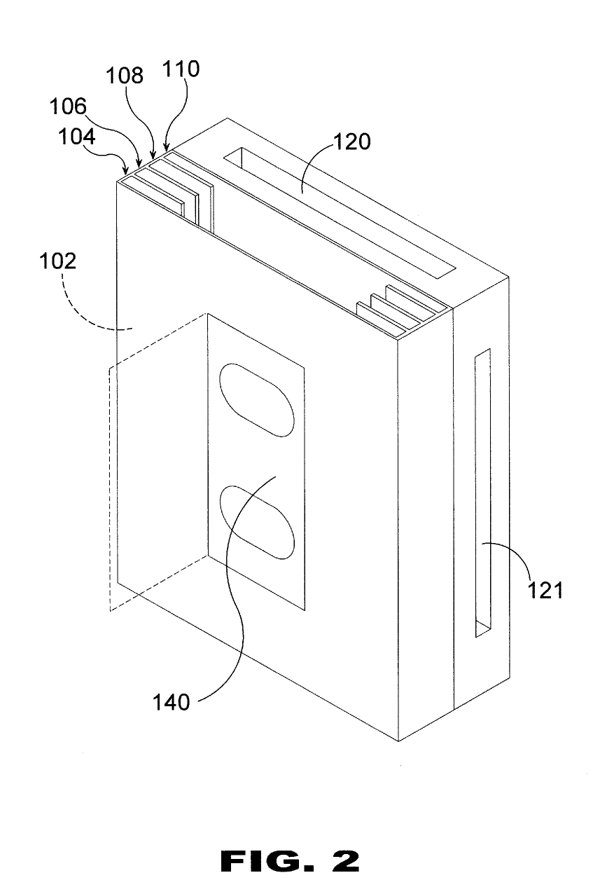

FIG. 2 is a generalized rear view of the primary telecommunications device 100 showing slot 120, located at a top surface, and slot 121, located along a side surface, for receiving, and thereby using, a video core processor therein. Similar slots for allowing a removable connection to the primary telecommunications device by a video core processor are also located along a bottom surface and a side surface opposite the surface having slot 121. Further illustrated in FIG. 2 is storage bay 102 having slots 104, 106, 108, 110 for retaining video core processors that are not currently being utilized. Along the rear surface of primary telecommunications device 100 are two slots 140 for allowing a user's fingers to better grip the primary telecommunications device. As will be shown in additional drawing figures, an alternative manner of allowing a user to securely hold the telecommunications device of the present invention provides a rotating finger bracket for three fingers of the user.

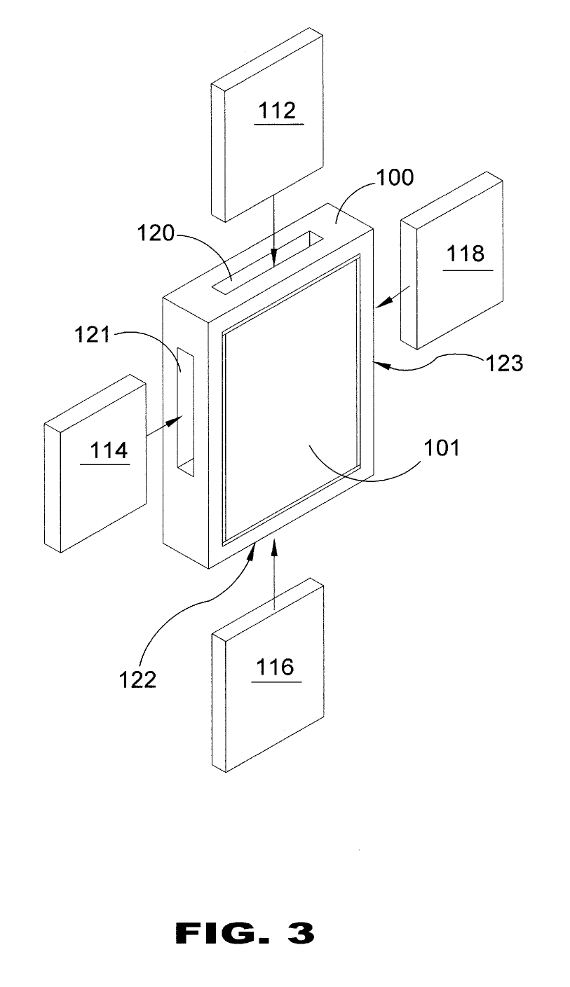

FIG. 3 is a generalized prospective, front view of the primary telecommunications device 100 of the present invention, which includes a primary front viewing screen 101 and slots 121, 122, 123, 124 located in each side surface, the top surface and the bottom surface thereof. Video core processors 112, 114, 116, 118 are removably connectable by insertion is any of slots 121, 122, 123, 124 of primary communications device 100.

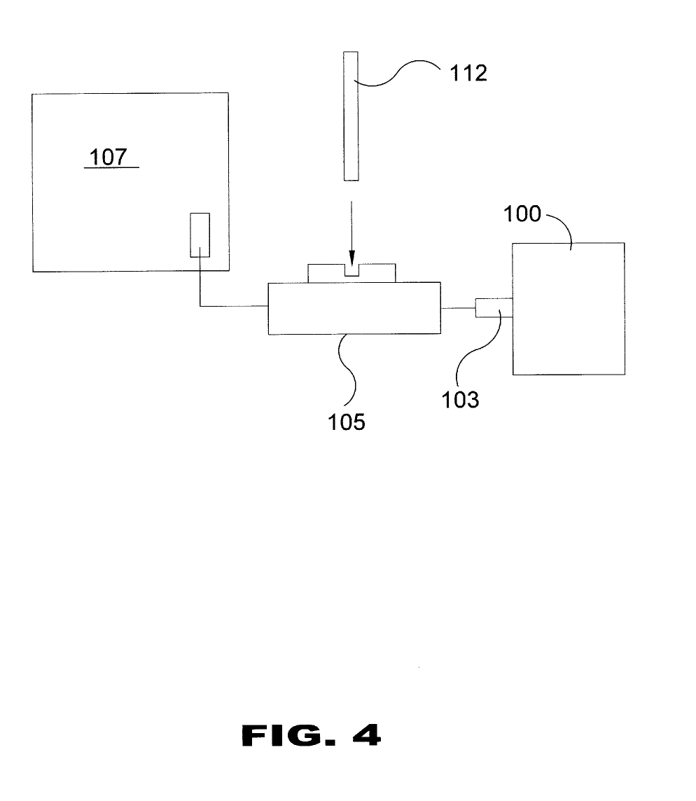

FIG. 4 provides an overall schematic view of the utility of the present invention. In this drawing figure, primary telecommunications device 100 is shown as having a USB port 103, which is connectable via a cable to a docking station 105. Docking station 105 includes USB ports for receiving one or more video core processors 112, 114, 116, 118 (only one is shown in FIG. 4, however a plurality of USB ports are clearly possible and within the scope of the present invention.) Docking station 105 is also connectable to a personal computer 107, which personal computer devices generally include a multiplicity of USB ports. By docking a VCP into the docketing station, the uploading or downloading of data and other types of files, including application programs, to, and from, any video core processor, as well as to and from the primary telecommunications device 100 becomes quite feasible and expeditious.

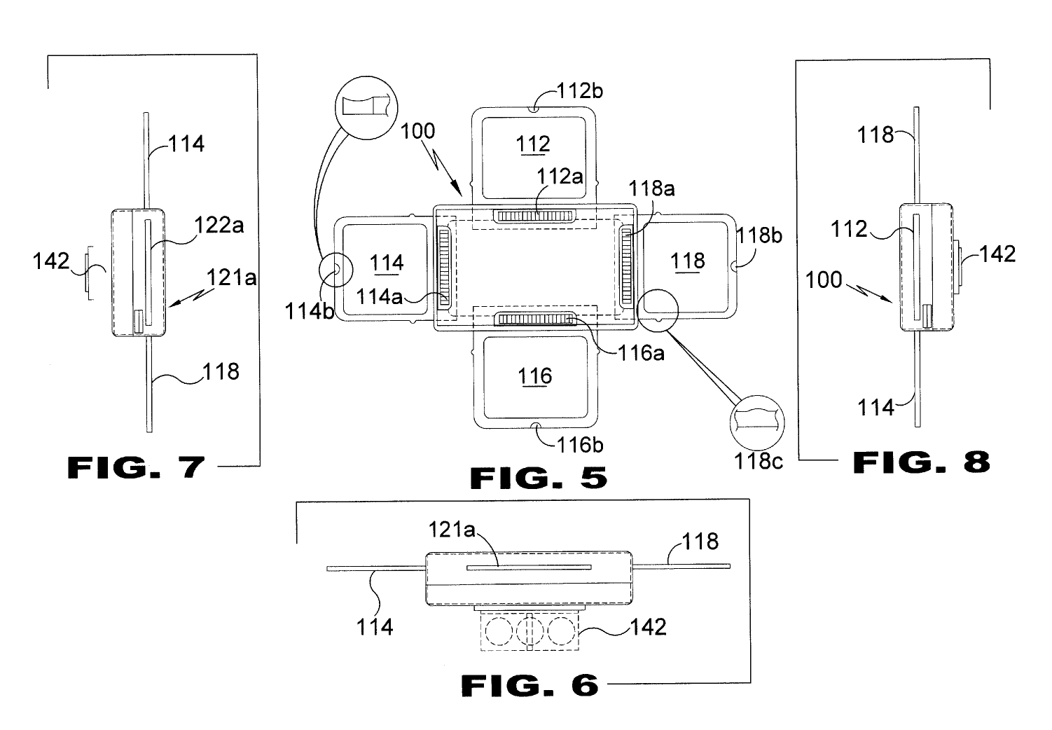

FIG. 5 is a detailed plan view of the primary telecommunications device 100 with video core processors 112, 114, 116, 118 being connected to, and extending from, module connectors 112a, 114a, 116a, 118a. Preferably, each video core processor includes a finger grip 112a, 114b, 116b, 118b at an edge of the VCP that is distal to the primary telecommunications device. Additionally, a detent 118c is preferably provided to lock, or secure, each video core processor in a slot located in the back cover of the primary telecommunications device in a manner that would be generally known to those skilled in the relevant art.

FIG. 6 is a detailed side view of the primary telecommunications device 100, which shows in phantom a possible position for a rotating three-finger bracket 142 for allowing a user to more securely hold the present invention. In this view, video core processors 114, 118 can be seen as extending from each side surface of the primary telecommunications device. On an additional side surface of primary telecommunications device 100, an access door 121a for slot 121 is represented in FIG. 6 for permitted a removable connection with the primary telecommunications device by a VCP 112, 114, 116, 118.

FIG. 7 shows a detailed bottom view of the primary telecommunications device 100 of the present invention, which includes an access door 122a for video core processor 122 and video core processors 114, 118 connected on either side surface of the primary telecommunications device. The preferred embodiment for permitting a user to securely grip primary telecommunications device 100 is rotating finger bracket 142, which is located on the surface of the storage bay 102 for non-in-use video core processors.

FIG. 8 is a detailed top view of the telecommunications device 100 from which view can be seen video core processors 112, 114, 118, along with rotating finger bracket 142.

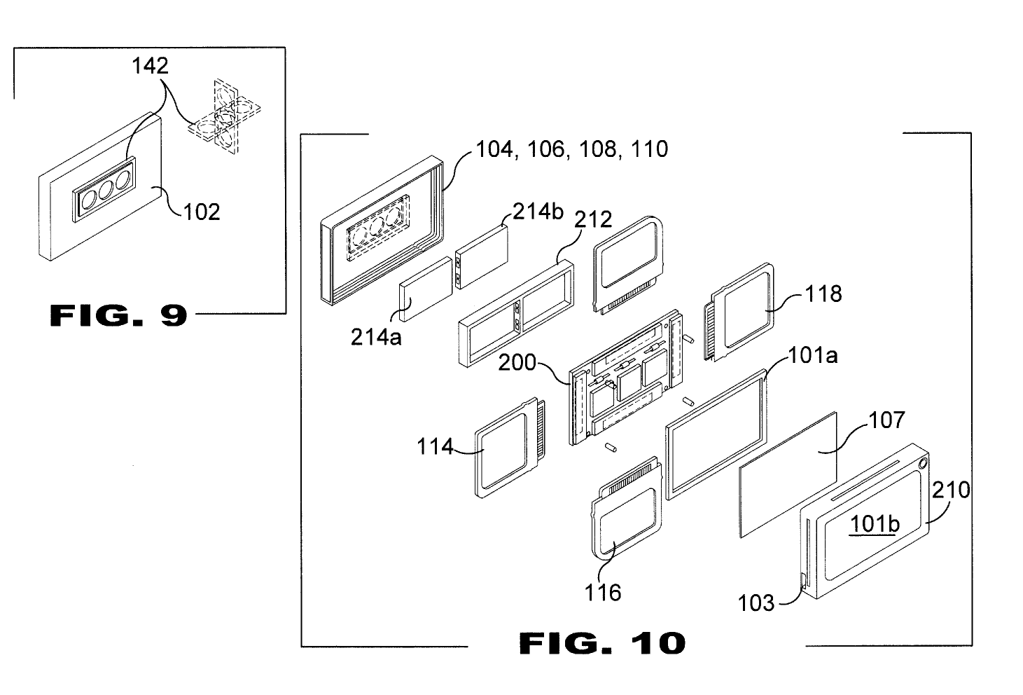

FIG. 9 is a detailed back view of a portion of the primary telecommunications device 100 of the present invention showing the rotating finger bracket 142 thereof and manner of possible rotation, which rotating finger bracket is located on the back cover, or back surface, of the storage bay 102 of the primary telecommunications device.

More particularly, when all of the video core processor screens are extended from the primary telecommunications device into operational position, the overall size of the package becomes too unwieldy to hold in the palm of the hand of nearly any normal sized person, and virtually impossible to hold to a users ear in order to make a conventional telephone call. People of smaller stature will encounter even larger problems with handling primary telecommunications device and a solution needed to be formulated.

This problem is overcome by the incorporation of a folding finger hole support in the back of the primary telecommunications body. The finger hole support is simply put into operation by unfolding the recessed support bar located on the read surface of the unit. It unfolds to remain orthogonal to the back surface. In its most preferred embodiment, as illustrated in FIG. 9, rotating finger bracket 142 has three holds into which the user inserts the index, middle, and ring fingers. By the gentle cupping of the palm, a firm grip of the primary telecommunications body is created, making it virtually impossible for a user to drop or lose control of the mechanism. The finger support bar can be rotated to a 0° and a 90° detented position.

In the 0° position the incorporated support allows for the holding of the primary telecommunications device in the horizontal lengthwise direction from the heel of the palm to the fingertips, and in the 90° orthogonal direction where the unit sits in the vertical direction.

The finger hole support allows for the user to initiate the touch screen without the fear of dropping the primary telecommunications device. The incorporated finger support allows the user to grasp the primary telecommunications device 100 while offering a stable grip on the body of the unit while pushing and pulling the additional screens in and out of operation. The incorporated finger support allows the user to grasp the primary telecommunications device 100 while offering a stable grip on the body of the unit while inserting or removing the audio headset connector interface without the fear of dropping the primary telecommunication device.

Specifically, in this the most preferred embodiment, there are two incorporated system features that address these problems: The first feature is a mechanical finger locking support located on the back surface of the body of the primary telecommunications device. This three-holed bar 142, as illustrated in FIG. 9, folds out perpendicularly to the rear surface of the primary telecommunications device offering access holes for the index, middle, and ring fingers. When fingers are inserted in these holes, a simple cupping action of the fingers creates a positive locking hold of the primary telecommunications device 100 in the palm, making it virtually impossible to drop from the hand. The second feature is a 90° rotational joint of the finger support bar that lets the primary telecommunications device to be spun orthogonally in the palm of the hand while still maintaining the positive finger lock on the body of the primary telecommunications device, allowing the screens to be viewed at a right angle to their original position.

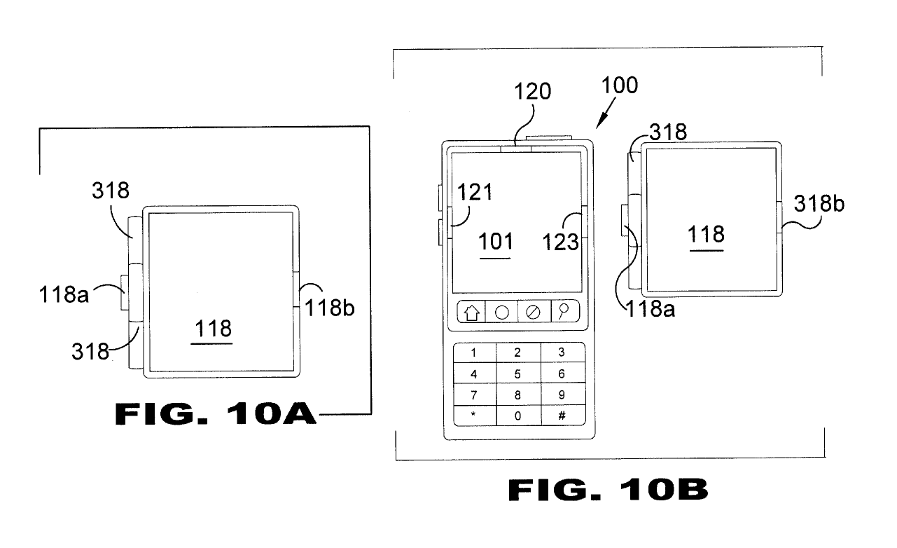

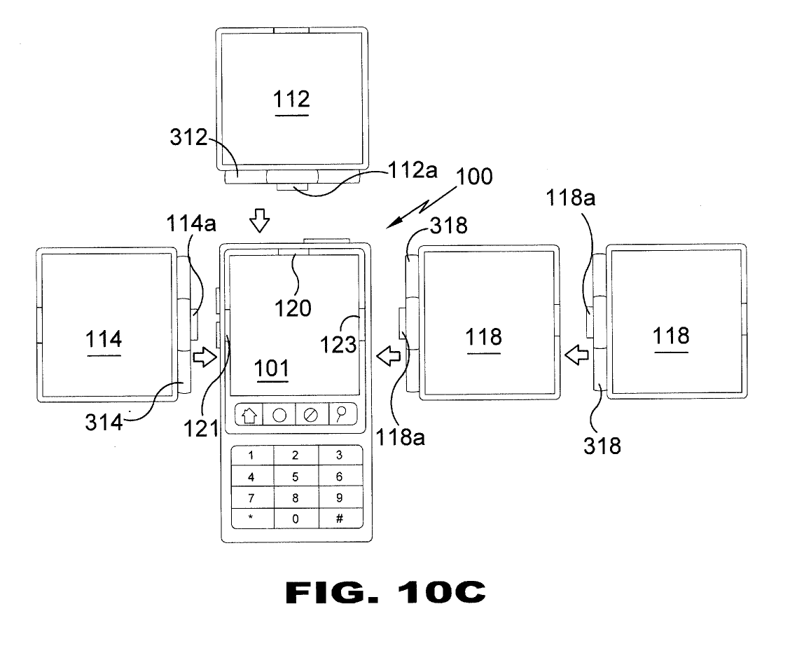

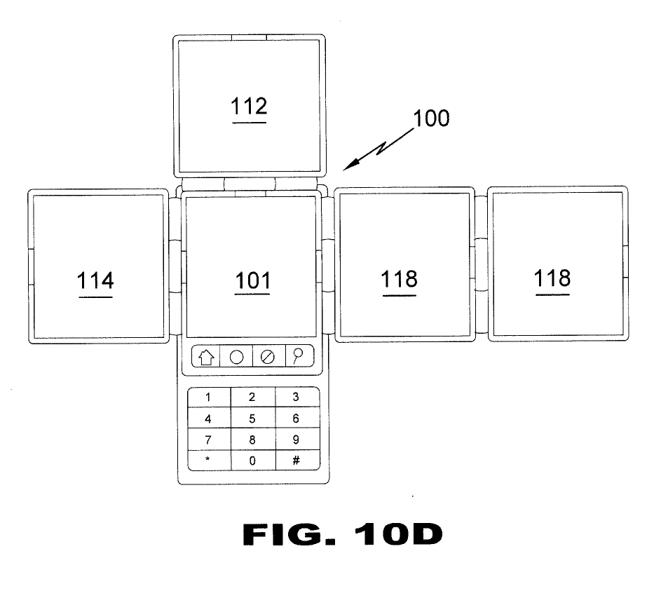

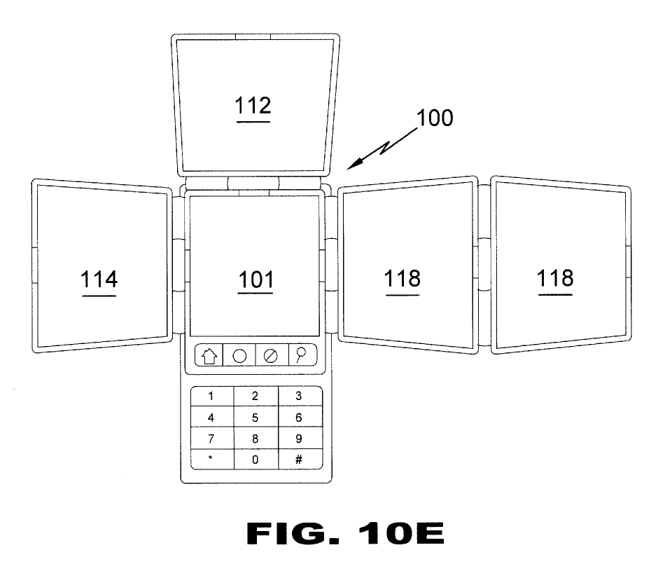

FIG. 10 is a detailed exploded perspective view of a preferred embodiment of the primary telecommunications device 100 of the present invention. Centrally located in FIG. 10 is a main computer processing unit (“CPU”) 200, which functions in much the same manner as a microprocessor would in either a personal computer or “smart phone.” Along the same plane of the view of FIG. 10 are video core processors 114, 118, which would be detachably connectable in the side slots 121, 123 of the primary telecommunications device. Vertically in the same plane as the main CPU 200 are video core processors 112, 116, which would be detachably connectable in slots 120, 122.

Proceeding in a forward fashion in FIG. 10 from main CPU 200 is a main, or primary, display screen bracket 101a for primary display screen 101. Further illustrated in FIG. 10, in the foreground before the primary display screen is a case 210 having a main display 101b. Further shown in connection with case 210 is USB port 103 for the primary telecommunication device 100. Clearly, the primary telecommunications device can include a plurality of USB ports, notwithstanding only one being shown in FIG. 10.

Proceeding in a backward fashion in FIG. 10 from main CPU 200 is a battery holder 212 and batteries 214a, 214b. In addition, FIG. 10 shows rear case 102, which also acts as a storage bay with storage slots 104, 106, 108, 110 for video core processors 112, 114, 116, 118 when not in use. Finally, the inner side of rotating finger bracket 142 can be seen in the view of FIG. 10.

FIG. 10A is a plan view of a preferred embodiment for a video core processor 118 having a barrel hinge 318 with a plug 318a that is connectable to the primary telecommunications device 101 and, as further preferred, with a port 318b located on an opposing edge of the video core processor 118 for receiving the plug of the barrel hinge of an additional video core processor. FIG. 10B shows the video core processor 118 of FIG. 10A having a barrel hinge 318 prior to being plugged into, or detachably connected, to the primary telecommunications device 101. The plug 118a of video core processor 118 inserts into the receiving port 123 of the primary telecommunications device 101 or into a receiving port 318b on a comparable video core processor 118, as shown in FIG. 10B. Once inserted, the barrel hinge 318 allows the video core processor 118 to move forward or backward on the barrel hinge 318. FIG. 10C shows a plurality of video core processors 118 of the preferred embodiment shown in FIG. 10A prior to connection to the primary telecommunications device 100. FIG. 10D shows the plurality of video core processors 112, 114, 118 of the preferred embodiment of FIG. 10A and those of FIG. 10C, as connected. FIG. 10E shows the plurality of connected video core processors of FIG. 10D with the barrel hinges 312, 314, 318 being rotated in certain instances to show flexibility between adjoined video core processors.

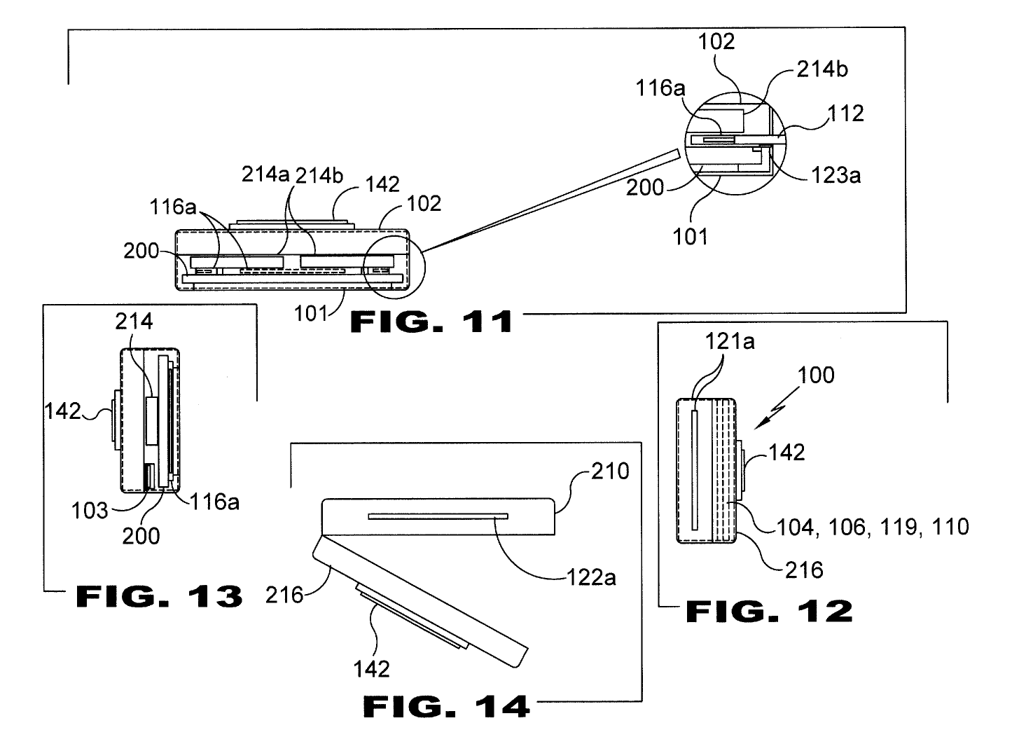

FIG. 11 is a detailed expanded bottom view of the primary telecommunications device 100 enlarged view of a corner of the portion thereof showing greater detail including a sensor for a power supply obtained from battery power. More particularly, FIG. 11 indicates the relative location of the main, or primary, display screen 101. Behind the primary display screen is the main CPU 200 and a connector 116a for video core processor 116. Two batteries 214a, 214b can also be seen in the view of FIG. 11. It should be stressed that the illustration of two batteries as a power supply is only one possible power source and that shown in the drawing figures is not intended to limit the scope of the presently disclosed and claimed invention. The rotating finger bracket 142 is shown as being located on the outer surface of storage bay 102.

The enlarged view of a corner portion of FIG. 11, in addition to the showing the primary display 101, the outer surface of storage bay 102, connector 116a for video core processor 118 and the corresponding access door 123a, and battery 214b, further shows a sensor 220 for sensing the presence of batteries 214a, 214b and for smooth and efficient operation of the power supply, whether being operable via batteries or a charging power supply.

FIG. 12 is an additional detailed top view of the primary telecommunications device 100 of the present invention showing a plurality of slots 104, 106, 108, 110 for retaining video core processors 112, 114, 116, 118 when not in use. Access doors 120a, 121a for slot 120, 121 for detachably connecting video core processors are also denoted in FIG. 12. Finally, a rear access door 216 is indicated for allowing access to batteries 214a, 214b.

FIG. 13 is a further detailed bottom view of the primary telecommunications device 100 showing preferred locations for a USB port 103, main CPU 200 and battery 214 locations within the primary telecommunications device. The relative locations of rotating finger bracket 142 and connector 116a for video core processor 116.

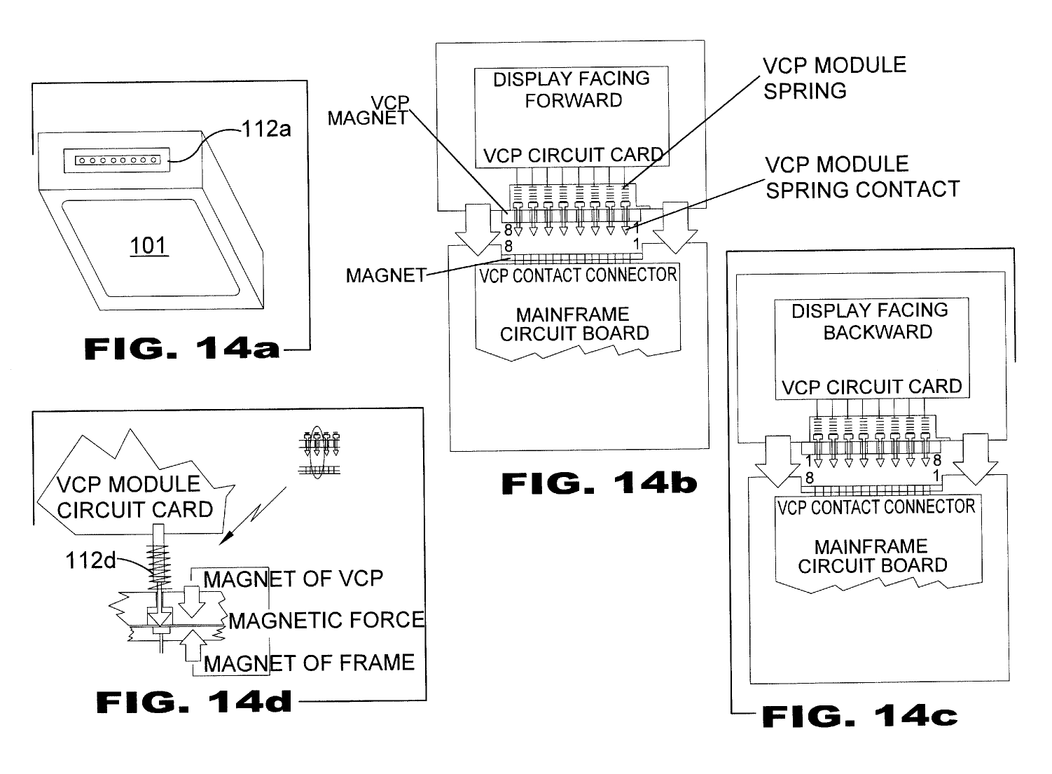

FIG. 14 is an additional bottom view of the primary telecommunications device 100 of the present invention showing a rear access door 216 for accessing the battery supply of the primary telecommunications device, as illustrated in an open position

FIG. 14A shows a preferred embodiment of one of four possible video core processor connectors 112c as a breakaway point contact style for the primary telecommunications device 100 of the present invention. It should, of course, be understood that each side of the primary telecommunications device, as illustrated in FIG. 3 and as generally described herein, would preferably have a similar video core processor connector as that illustrated in FIG. 14A and has now described in great detail.

Specifically, the preferred embodiment of video core processor connector 112a, as shown in FIG. 14A, comprises one hard surface on the primary telecommunications device 100 and is preferably made with a hard-point contact surface, gold-plated for conductivity, in an array of eight places, which may be, but need not be, a linear array.

FIG. 14B shows that the video core processor modules are equipped with eight spring-loaded movable points that will make electrical contact when engaged with the connector surface of the case of the primary communications device, and their associated magnets. The electrical design of the primary telecommunications device is such that the VCP display can be attached to the case of the primary telecommunications device allowing the display to be viewed in the front or, as shown in FIG. 14C, the VCP module can be disconnected, turned 180°, and replaced onto the same connector 112a for the display to be viewed from the rear. In the event of dual-screen video core processors, this preferred embodiment of the present invention eliminates the necessity of worry about plug-in of the VCP module in an incorrect manner, as it will be operational in either forward-facing or rear-facing directions.

FIG. 14D shows, in enlargement, greater detail of the point contact pin of the preferred embodiment of FIG. 14A. More particularly, in FIG. 14D, a spring 112d is used to insure that there is sufficient mating force to guarantee electrical contact, with the convenience of zero insertion due to the fact that the conventional pin-socket arrangement has been eliminated.

When the VCP module 112 is brought into proximity of the frame or outer surface of primary telecommunications device 100, the high-efficiency magnets that are part of the video core processor and the primary telecommunications device come within their magnetic sphere of influence and are immediately attracted to each other and lock together. The magnetic force is in excess of the spring force of the video core processor point contact pins and are therefore compressed for producing the required mating force needed to guarantee reliable electrical contact.

Disconnecting a video core processor 112, 114, 116, 118 from the primary telecommunications device 100 is rendered as simple as grasping the VCP body and pulling to overcome the retention force of the magnets, thereby causing the two components to separate. The spring-loaded contacts, when engaged, also offer shock protection should the user drop the primary telecommunications device or impart a large magnitude of mechanical distress to it. Sufficient mechanical shock will cause the eight-spring loaded contacts to exert enough pushing force to automatically disengage the video core processor from the primary telecommunications device, therefore protecting it from permanent physical damage by diverting the impact energy into the mechanical motion of separation instead of having the body of the primary telecommunications device or video core processor(s) attempt to absorb such force.

### Circuitry for the Primary Telecommunications Device

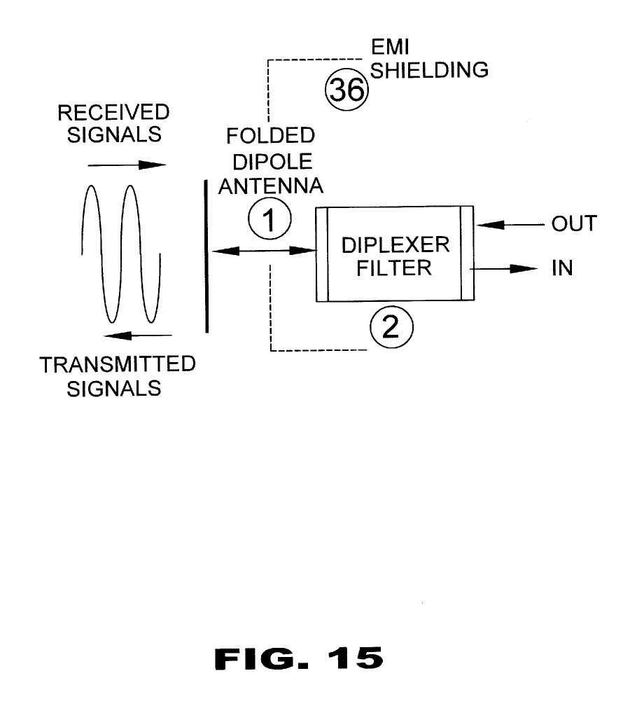

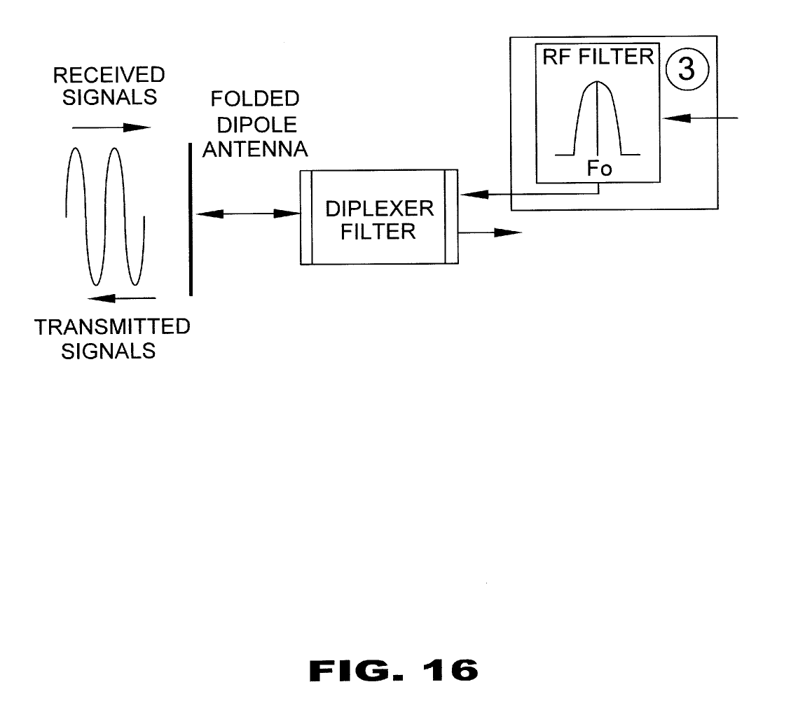

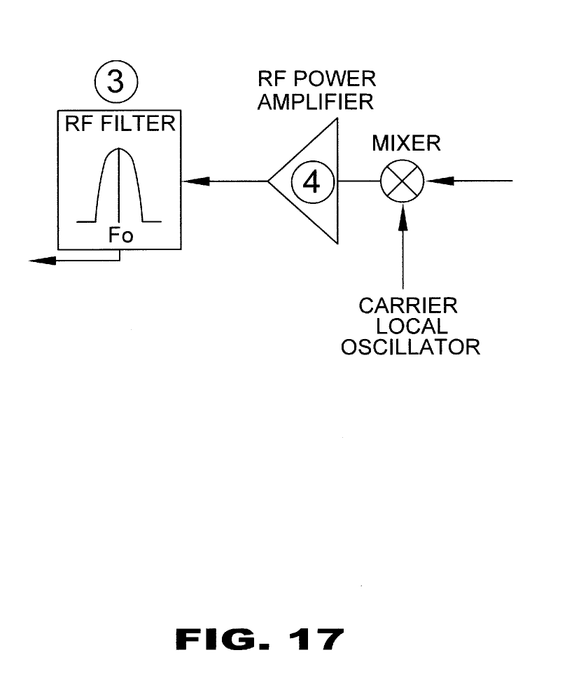

As presented in the circuit diagrams of FIGS. 15-19, the primary telecommunications device will employ an omnidirectional dipole that allows for a compact size, accurate frequency tuning, power handling capacity, and the ability to interface with 36, a polymer-based electro-magnetic interference (“EMI”) shielding surface. Dangerous EMI (defined as the property by which electrically-powered devices cause undesirable operation in other electrically operated units when coming within a defined proximity of each each by the generation and acceptance of unwanted radiated magnetic fields) will be greatly reduce for the user as the levels of transmitted RF (radio frequency) power will be shielded from the user's body. The use of a Bluetooth® transceiver 22 will reduce the EMI exposure even further as the primary telecommunications device will therefore not be required to be held to the ear in order to make a call or hear audio information, etc. The primary telecommunications device RF transceiver dipole antenna 2 will employ a diplexing filter. This dual surface acoustic wave diplexing filter will have the capacity to allow the high RF power of the transmitter power amplifier 4 to pass through in one direction while allowing the very low power RF signal of the receiving antenna 1 to pass through in the other direction.

The two paths of the diplexing filter will fork to the RF Filter 3 and to the RF LNA (low noise amplifier) 5. The RF Filter 3 will remove all excess harmonic interference signals that have been theoretically generated from the transmitter mixer 6. This filter is required to insure that the transmission signal remains within the registered frequency spectrum of the channel assigned to that phone. Without the RF filter, the transmitted power would contain frequencies that are outside of the allotted channel and would cause interference in other phones and communication devices that operate near the same frequency, which is a violation of the FCC regulations. The RF filter is fed with the RF power signal from the RF Amplifier 4.

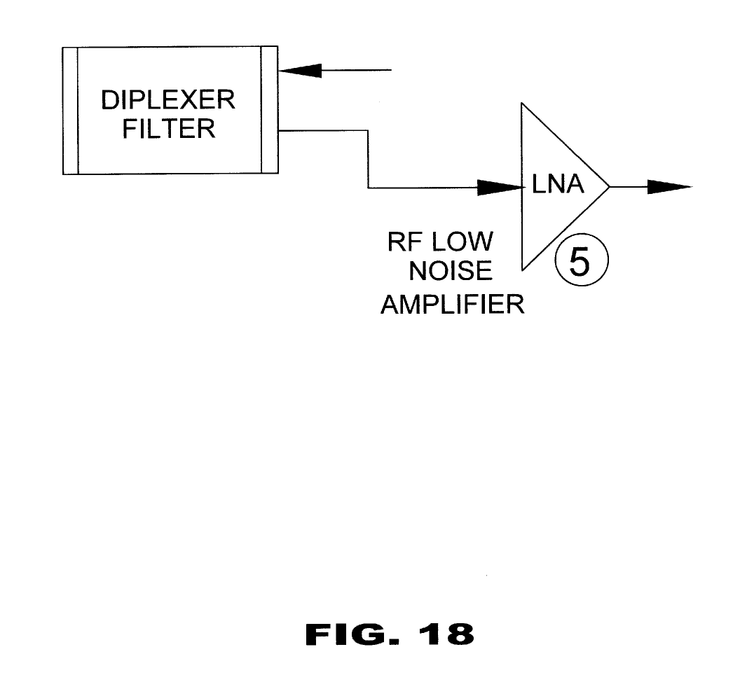

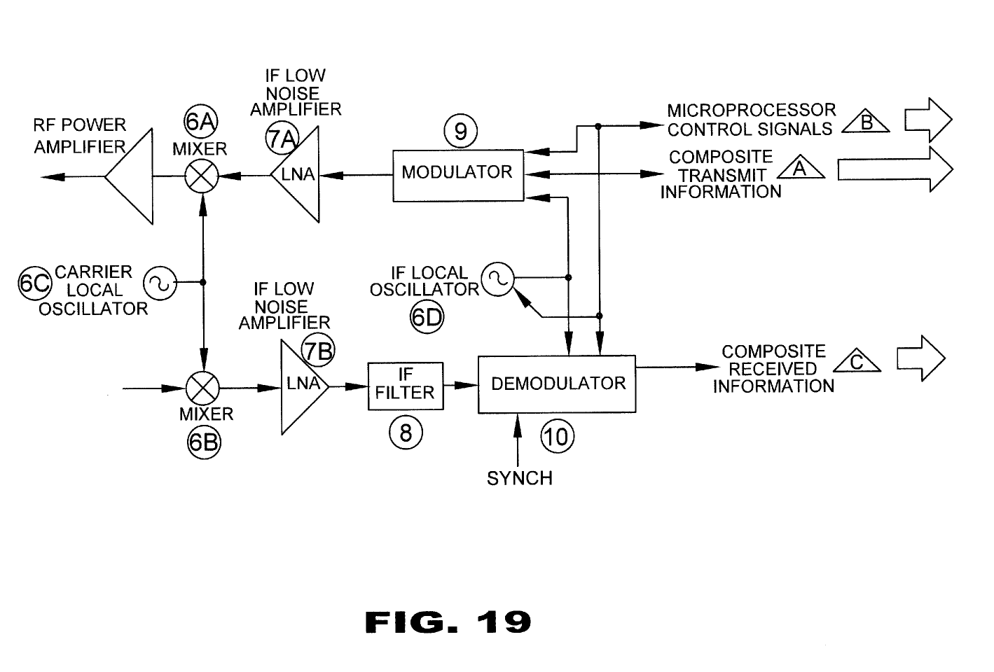

This semiconductor amplifier gain stage will boost the amplitude of the low level signal derived from the RF Mixer stage 6A, and the Carrier Local Oscillator 6C to the power level required for transmission to the closest cell tower, as represented by the circuit diagram of FIG. 19. This RF power will pass through the RF filter stage 3 and through the diplexing filter 2 until it reaches the transmitting antenna 1. As referenced in FIG. 18, the RF LNA is required to boost the very low level signals from the receiving antenna to an appropriate level for processing in the follow on mixing stage 6B. In the case of mixer 6B, using the carrier local oscillator, this functional block subtracts the high frequency carrier signal from the signal processed through the receiver LNA 5. Since the mixer 6C subtracts the high frequency signals from the received signal, the resultant signal represents the low frequency data that is intended to be received.

In the transmission channel, mixer stage 6A, in concert with the carrier local oscillator 6C, will combine (or add) the lower frequency data signals generated by the modulator 9, in combination with the IF (immediate frequency which is a frequency value that results from the mixing of low frequency signals and high frequency signals through a mixer), local oscillator 6D, subsequently amplified by the LNA 7A, to produce a transmittable signal to be sent to a cell tower for processing.

The modulator 9 acts as another form of mixer that combines the lower frequency composite transmission data to be sent, |A|, and the microprocessor control signals |B| which results in the properly encoded signals that are required to be transmitted to the cell tower as part of a communication message stream.

In the receiver channel, mixer stage 6B, in concert with the carrier local oscillator 6C, will operate in the reverse of mixer 6A and subtract the carrier local oscillator frequency from the high frequency received signals from the antenna, resulting in the retrieval of the data envelope sent to the primary communications device by the cell tower transmitter.

The data envelope from mixer 6B will then require further processing. First, since mixer 6B output level is a low level signal, it will require amplification to a more suitable level. LNA 7B accomplishes the task of boosting the signal without creating unwanted noise within itself. The boosted signal of the LNA 7B feeds an IF filter 8, which will pass only the frequencies required for the demodulator 10 to operate. The demodulator 10 acts as another form of mixer that combines the lower frequency data from the LNA/IF filter and the microprocessor control signals |B| which is used to extract the originally transmitted signals from a cell tower |C|.

The demodulator 10 is fed by different microprocessor generated synchronization signals depending on the type of data stream there is to decode. The synch separator 15 detailed hereinafter will create digital signatures such that the applications program running within the microprocessor will be able to recognize and determine the required type of demodulation signals needed at any point in the transmission.

The digital microcomputer section of the primary telecommunications device platform is divided into three basic sections, as are all computers:

The first section is the CPU, or central processing system. The primary telecommunications CPU divides its performance into sub-processors to speed up the ability to handle data, and is commonly known as a “star” control configuration. In this manner, the main CPU simply controls all the sub-processors at their top speeds, and correlates the input and output data without having to slow its own processing power by executing the creation and manipulation of the input and output data itself.

The primary telecommunications device's sub-processors include, but are not limited to, the A/D and D/A controls, memory storage, audio processor, video processor, screen multiplexor, control synchronization, battery management, and deployed video processor module controls.

The second portion of the primary telecommunications computer circuitry is the memory section. Memory and memory control includes, but is not limited to, program memory for the execution of the operating system, custom user applications, video buffering, touch screen interface, and audio processing.

The last of the three sections of the operating platform is the Input/Output arrangement. All computers must have the ability to have information and control requests enter and exit the system. The system of the primary telecommunications device is equipped with, but not limited to, touch screen requests for operating conditions. The system includes high-resolution viewing platforms that include, but are not limited to, E-INK, LC, or LED, and illumination generators that include, but are not limited to E-L or LED technology. In addition, the system of the primary telecommunications device includes, but is not limited to, audio processing circuitry that provides high sensitivity microphone input amplifiers and noise filters, high level output speaker drives and a Bluetooth® interface for a remote audio I/O headset.

The system of the primary telecommunications device, using the multi-video requires special electronic handling of received data when used in a conventional single screen carrier protocol environment used by the current cell phone service providers.

The primary telecommunications device of the present invention, as a multi-core video processing and viewing platform, without any customized application software, would only be able to display the service providers single screen video message contained in their CDC transmission stream.

To address this problem, primary telecommunications device is equipped with sufficient memory to hold and perform a specialized application program for the manipulation of multiple screens of video information by decoding sequences of screen frames and storing them in a video cache memory section for separation and simultaneous viewing by downloading the video data to separate detachable and software reconfigurable core video processors. This specialized application software will allow primary telecommunications device to operate as a multi-image viewing system while operating in a conventional single screen data stream contained within a presently standard transmission of current service providers. The only sacrifice this mode of operation will endure will be a slight reduction of throughput while the device's main CPU 200 performs the dissemination of the video data to the multiple video processing cores attached to the mainframe of the primary telecommunications device in the form of the detachable and reconfigurable viewing modules.

For the primary telecommunications device to operate at its optimum performance level, a specialized composite data content stream will be required that must be created and transmitted by a service provider.

The custom composite data content stream will have all the multiple screen content embedded within the transmission and will not require the CPU of the primary telecommunications device to decode and then encode single screen transmissions into compatible multi-screen projections.

In either case, the CPU operating system will be able to run either a pseudo-multi-screen application whereby the multi-screen data is compiled as a collection of multiple single screen images, or the true multi-screen application whereby a custom composite data content stream contains the multi-screen format embedded within it, without the need for time wasting manipulation.

The digital platform for the primary telecommunications device provides for an application whereby the audio channel processors feed a fast Fourier network for the determination of the frequency content of received audio tones so that applications dependent on specific patterns can be initiated.

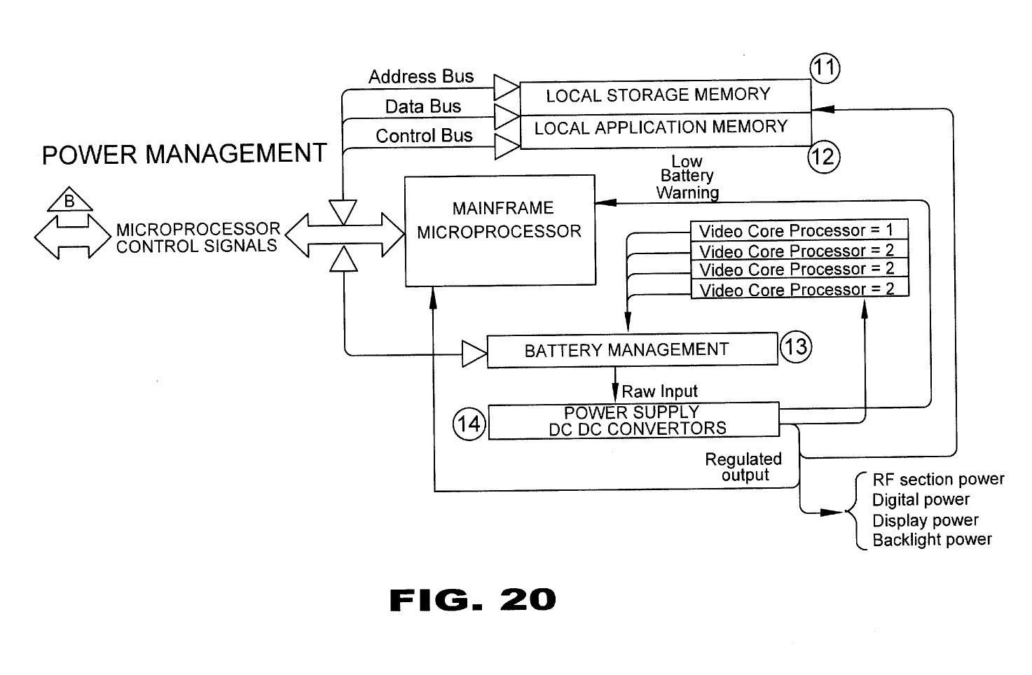

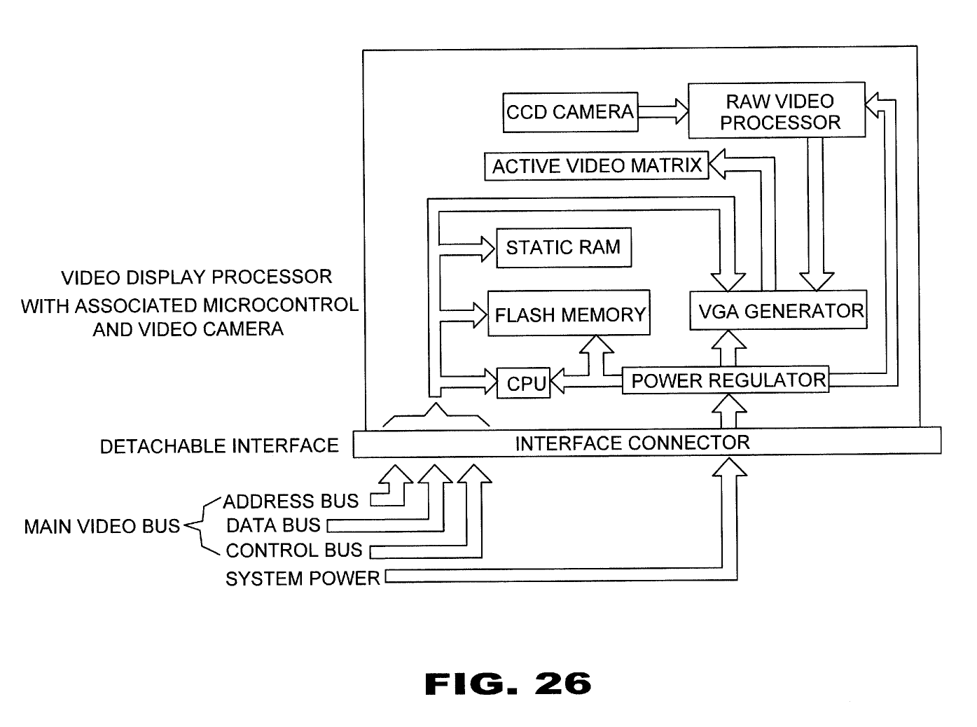

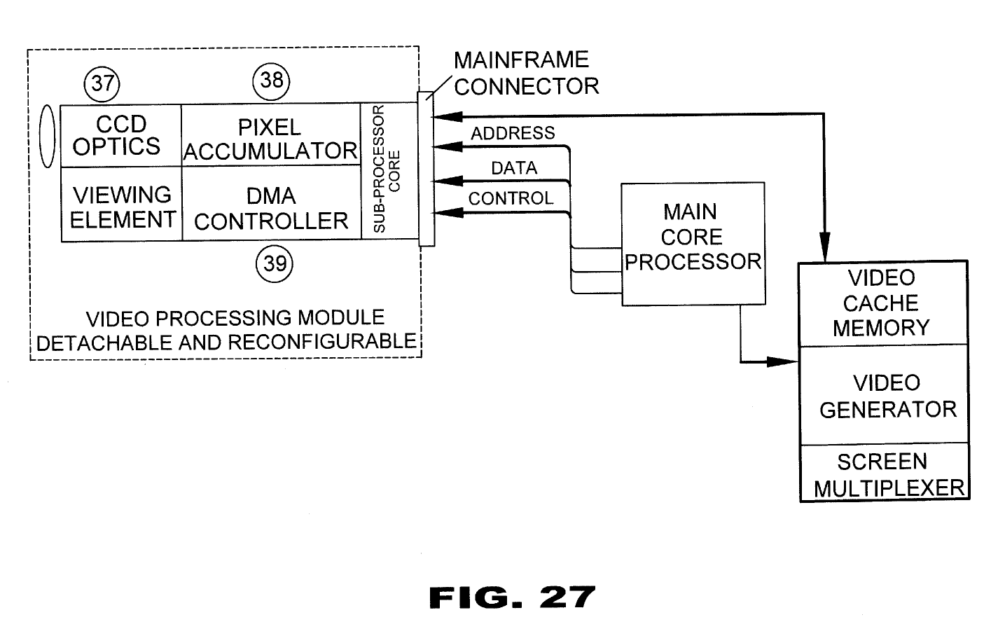

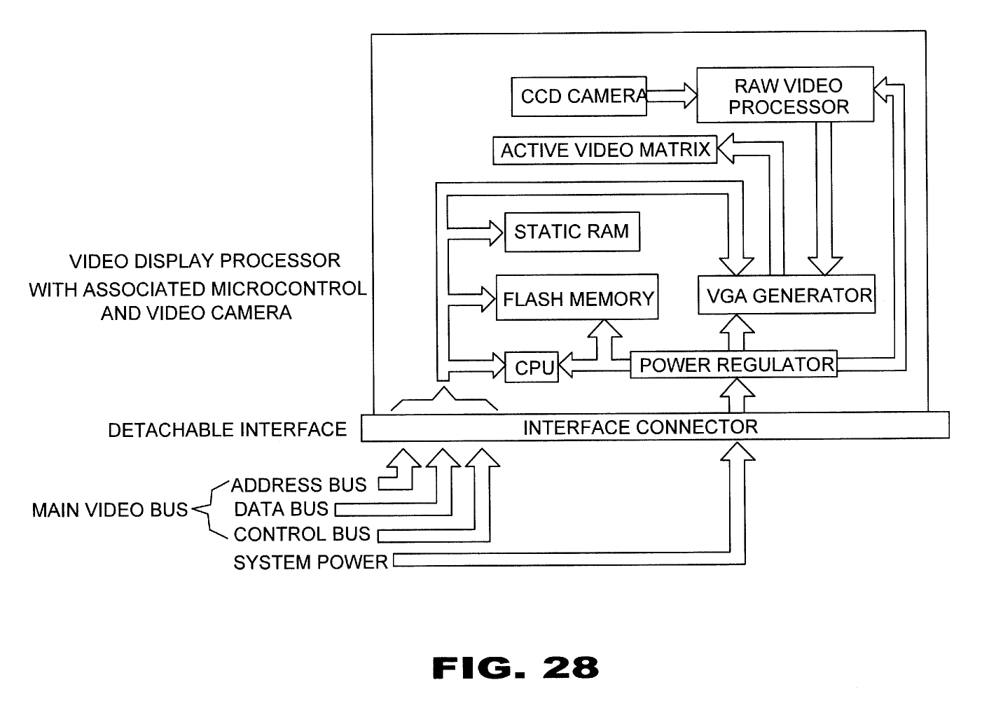

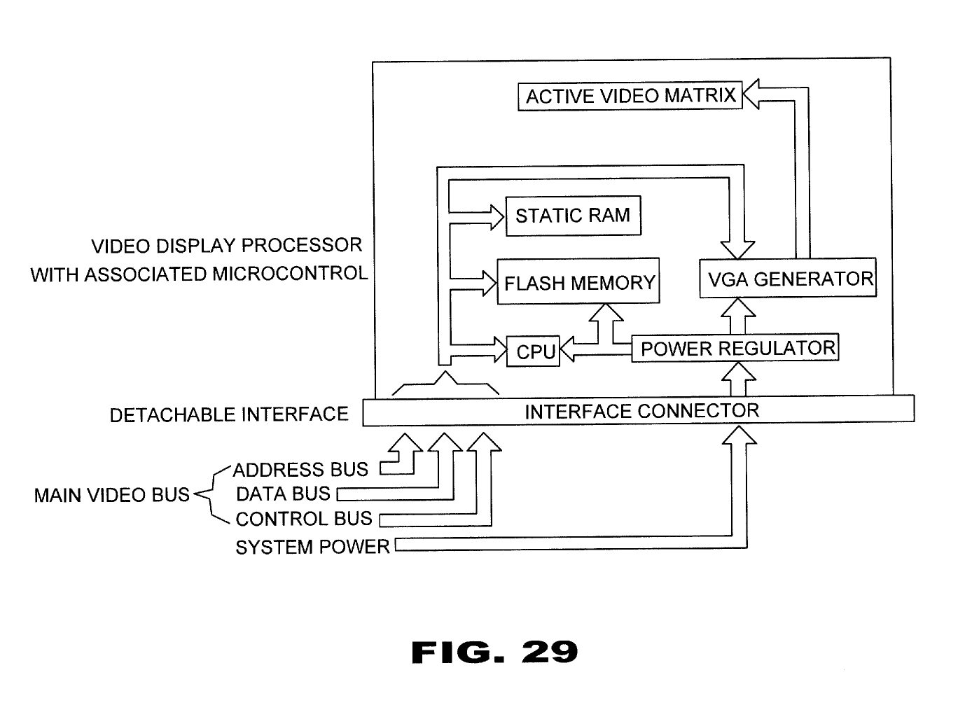

Referring to FIGS. 20-29, the primary telecommunications device has memory divided into two sections for the purpose of independent support of, but not limited to, video files, audio processing, touch screen interface, and lookup tables such as telephone address books and the like. The memory section, through an independent DMA controller, independent access to the address bus, the data bus, and control bus is well suited for the purpose of storing and retrieving data from any block within the memory structure. Local storage memory serves the purpose of holding permanent and semi-permanent data for lookup when the operating system requests it, such as phone numbers, credit card numbers, account numbers, etc. Local application memory is also divided into two parts for the CPU to use as both temporary recall memory, such as on the fly calculations, video and audio processing, as well as the operating system program and associated data.

Power management is not handled in the same manner as most conventional telephone or mobile data platforms. The first major distinction is that primary telecommunications device has incorporated within the body of its frame two batteries 214. The present invention further incorporates a power management processor that uses sensor input to determine the level of usage of the features in determining the manner that the primary telecommunications device will respond to demands for power. Sensor inputs are used to detect how many detachable independent video processing and viewing cores are in use at any instant of time. This information, in concert with an internal battery use time calculator, determines the manner in which battery depletion warnings are created. As the total Ampere-Hour capacity of the internal batteries begins to decline, the battery management system alerts the user as to what course of action is desired to extend the life of the remaining battery power. The primary telecommunications device is intended to have the ability to auto-shutdown any, or all, of the additional plug-in video processing and viewing cores to conserve power, or to prompt, by user choice, which video processors are to be powered down. Unlike conventional cellular phones, the primary telecommunications device does not arbitrarily shut down when battery power approaches the lower voltage limits of its battery.

The primary telecommunications device is intended to perform two different computer-oriented power management tasks that extend battery life to its greatest extent:
The first task is to keep continuous track run time versus battery voltage droop to keep an accurate account of potential operational time for the system as a whole.
The second task is to continuously prompt the user as the battery droop begins to impact on the potential runtime of the system and request shut down of unused or unnecessary features that are still being powered.

The primary telecommunications device, in a preferred embodiment, further incorporates very high efficiency DC-to-DC converters that accomplish the two most significant tasks that are required for any battery operated device:
The first feature of the DC-DC conversion section is the low loss in converting the available battery power to the necessary and diversified voltages needed to run the various circuit elements.
The second feature is the ability to offer stabilized output voltages despite a significant voltage droop of the battery power as the system continues to operate. In addition, the two system batteries are power “or” wired so that the can individually power the DC-DC conversion section. As the battery voltage droops to the point where switchover is required, the battery management supervisor will send a message to the CPU section so that a message will appear on the screen, and then divert power from the secondary battery to power the primary telecommunications device. When the secondary battery is also drained to the point requiring switch-over, the battery management supervisor will switch in both batteries allowing them both to power the system as a last burst of energy to allow for the maximum amount of running time.

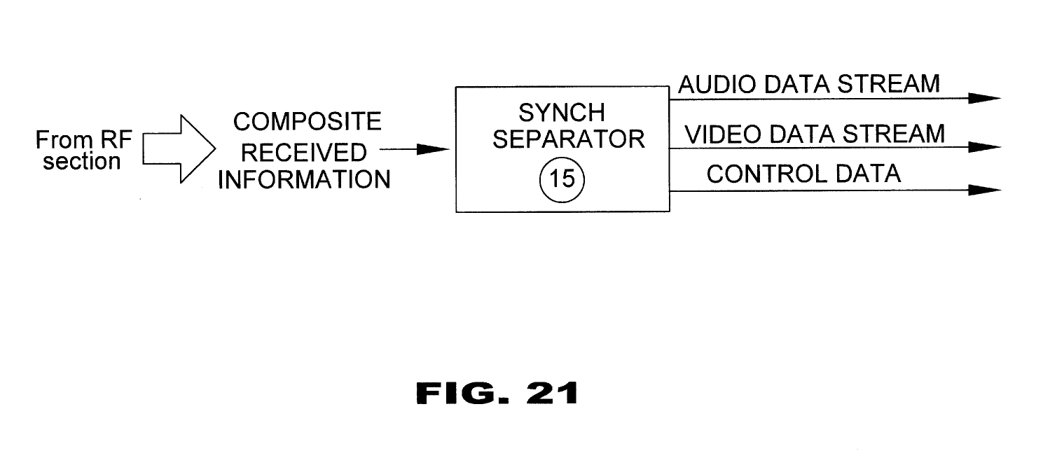

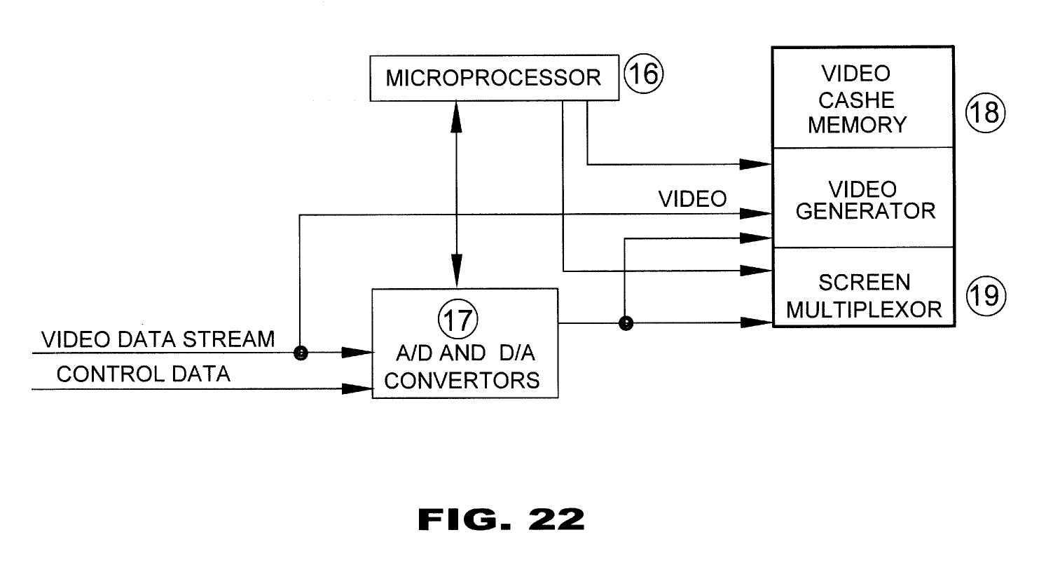

Referring to FIG. 21, synch separation will be required for the extraction of the different parts of the composite data content stream. Just as in a television, the horizontal and vertical synchronization pulses allow the video picture to be reassembled on a screen. The digital information that is held within the composite data content stream needs to be divided into its separate elements. These separate element streams will then be able to be converted into their analog counterparts by the D/A converters in section 17, as per the flow chart of FIG. 22. The audio data stream and the video data stream are fed to the necessary portions of the processing sections so that the original sounds a phone message or a downloaded audio file can be created, and the pictures that go with the sound can be presented my any of the multiple target screens.

Referring, again, to FIG. 22, the video data stream and the retrieved decoder signals needed to interpret the images are processed through the primary telecommunications device's main microprocessor and feed the circuit combination of the video memory cache that is collecting and coordinating the video and data streams. The main screen display is fed by the video generator that is forming the display patterns of the pictures from the stored video data, and the main CPU core is feeding any or all of the independent video processing cores that are deployed off of the main CPU frame, thereby vectoring the appropriate picture information to the proper detachable video processor module. The microprocessor 16 is also monitoring the sensor inputs from the video core processing module mounts to determine which viewing elements are deployed so that the CPU can determine which video processors are available for the presentation of video information. This deployment information will be used to determine which video packets of information will remain in the video cache memory for alternate display to any of the available video processors that are under microprocessor control.

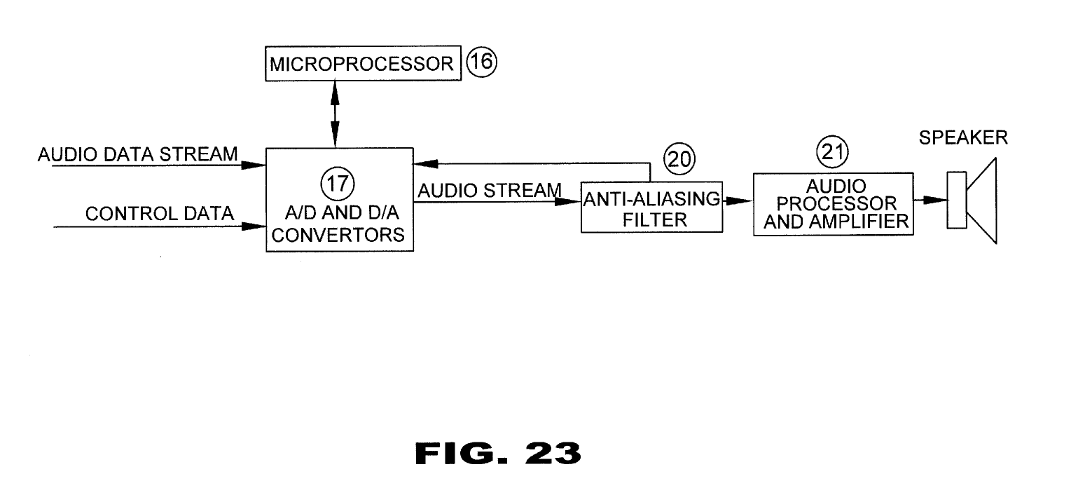

Audio processing for the primary telecommunications device, it should be noted that in order to have the same high quality sound recreation as that of a CD player, the audio channel will employ the use of an anti-aliasing filter 20, as referenced in FIG. 23. This filter will provide for the rejection of unwanted audio harmonic patterns from being generated during the recreation of the original sounds that have been interpreted into digital signals for transmission, and then received for the purpose of reconstructing them. This audio processing will require handshake signals from the CPU, the D/A converters that are changing the received digital data into analog patterns, and that of the anti-aliasing filter that strives to keep any unwanted rhythmic harmonic patterns from destroying the integrity of the reconstructed waveform.

The primary telecommunications device of the present invention, in a further preferred embodiment, will also be equipped with a high-fidelity audio amplifier and speaker with enough power for announcement volume and earpiece drive.

For the future development of the audio prompts that identify advertisement opportunities for sponsors equipped with the transmitting equipment, the primary telecommunications device may preferably be designed with the two electronic circuits that will allow these functions to be empowered: The first circuit is a level detector and limiter so that the magnitude of the input microphone signals to be processed will remain linear and will not be distorted. Distorted signals have a frequency content that is altered from its original content, rendering useless all of the data that was once contained within them. The frequency protected data passes through a computer controlled fast Fourier Transform that detects the frequency content and details the content of the input signal in terms of the individual frequencies that make up the signal. These signals are fed to the microprocessor so that any audio prompt signal patterns can be recognized and will allow software application subroutines to generate a call to a base server for information relating to the purpose of the prompt signal. This technique will allow the primary telecommunications device to recover vast amounts of information from a server by simply using a short sequence of tones to identify the information requested.

To allow the primary telecommunications device to operate as a conventional telephone, a Bluetooth® transceiver is built into the electronics. Bluetooth® connectivity gives users the ability to use remote Bluetooth® headsets to communicate phone calls, link to a computer, and log into any other Bluetooth® communications platform as long as the operating software application has been loaded onto the CPU of the primary telecommunications device of the present invention.

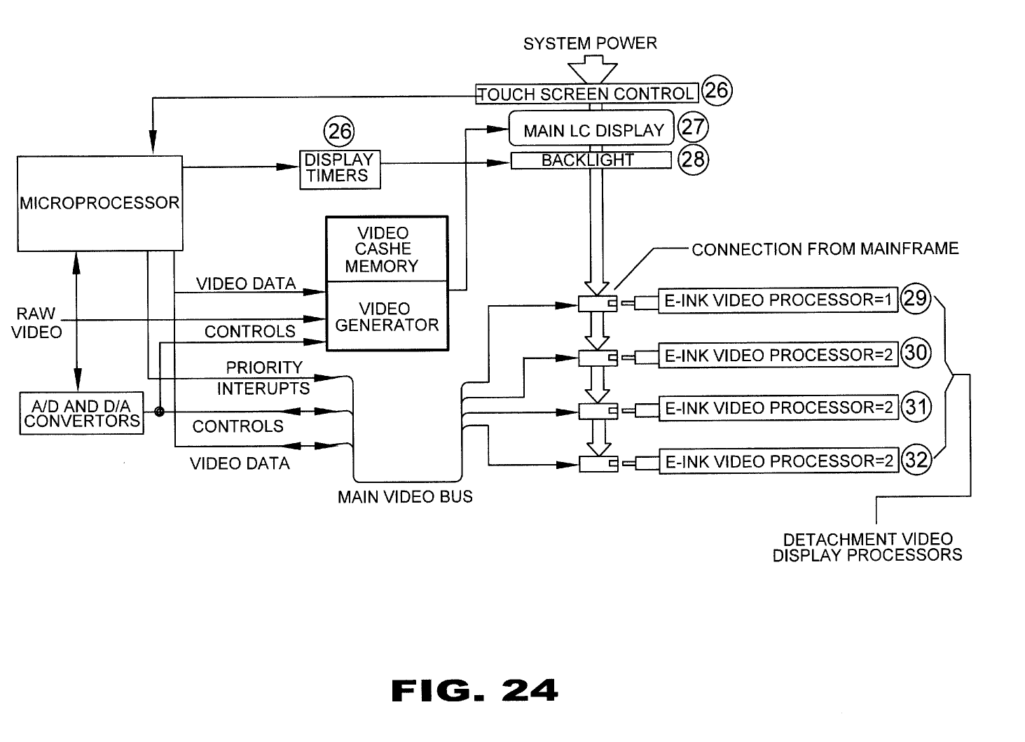

Referring to FIGS. 23 and 24, the manner in which received video information is handled, stored and viewed by the present invention differs from the prior art. The microprocessor system will have running in its core CPU one of two possible programs, enhanced by the additional cores running applications in the detachable video processors and viewing modules. The primary telecommunications device, when operating in a conventional data environment, will require an application whereby single screen images are received during regular transmission cycles from the carrier and stored in some sequence in the video memory cache circuits for appropriate display when the microprocessor program calls for them. The “pseudo-multi-screen” application offers a less than real time video message timing, but allows the more complex system of the present invention to operate in the existing technology framework of the current service providers until the custom CDC stream technology can be developed for transmission. The main frame CPU core will disseminate the appropriate video data to any or all of the video processors deployed and will appear transparent in operation, although the multi-channel CDC stream does not yet exist.

The primary telecommunications device, when operating in the custom CDC stream environment that is formatted with the multi-screen video content, an application will be running that directly addresses the proper video memory sequencing for memory storage and retrieval via any or all of the deployable video processing and viewing modules so that real time video messaging can be performed. This application allows the primary telecommunications device to operate at the optimal speed that it was designed to offer.

The primary telecommunications device of the present invention is not limited to four detachable, software reconfigurable E-Ink video core processing modules because of their near zero-power requirement when not processing an image, and a single LC or LCD display for main viewing.

The user may at any time remove from the rear storage rails any of the four additional detachable video processing viewing elements and plug them into the main computer body utilizing any of the four access doors that conceal and protect four multi-pin connectors that electrically interface with the systems main core processor, as shown, for example, in FIGS. 14A, 14B, 14C and 14D. Once plugged into any of the video access connectors, the detachable video processor modules become energized and can now display any of the secondary video signals being sent to the primary telecommunications device mainframe.

Once an application is running in the core of the microprocessor that suits the cellular service that it is running within, the program will set specific time limits for which the system main and detachable viewing elements will be supplied power. The proposed system using, but not limited to, one LC main display and up to four detachable E-Ink subordinate video processing viewing elements, will require a display timer 25, as presented in FIG. 24, that powers the backlight of the main display for the appropriate amount of time in order to allow the viewer to see video messages while executing smart shutdown to preserve the battery life. The largest user of display power is the front panel LC display that requires an electro-luminescent backlight that will require a full intensity to low intensity switcher in order to reduce power consumption. The suggested E-Ink viewing elements may or may not have backlighting, but if the MACH is manufactured with them, the main core CPU will be equipped with five output channel lines to turn each of the backlight optics on and off with respect to the time needed for a viewer to observe any screen, and shut it down when a reasonable time has expired.

As further illustrated in the preferred embodiment of FIG. 24, the primary telecommunications device is equipped with a main screen touch sensor 26 that in combination with the operating system subroutine, can detect individual pixel defined screen spots set aside for buttons and sequence spot identifications defined by finger depression on the touch screen surface and sliding to product directional vectoring values for the movement of displayed video data as well as other program exchanges such as change of applications.

The main display of the primary telecommunications device, again referring to FIG. 24, defined in this example, but not limited to, is a real time LC display capable of producing live action motion. An LED screen is also a viable option for the main screen. The main screen is equipped with an active electro-luminescent or LED backlight necessary to produce the proper color temperature and intensity for the viewing of displayed images.

As mentioned before, the backlight module is equipped with a timer under software control for the purpose of limiting the power consumption during the viewing and non-viewing portions of the operation of the system.

The primary telecommunications device subordinate viewing elements numbered 2, 3, 4 and 5, as referenced in FIG. 24, are in this example, but are not limited to, E-Ink viewing elements. E-Ink is the viewing element of choice due to its zero power requirement during its view time. The E-Ink display will require a short burst of power only when the display image is being driven onto the surface of the viewing element, and can be completely removed after the image has been established on the display surface as it becomes latched in the pixel matrix of the readout. E-Ink viewing elements have high background reflectivity, and usually do not require backlighting unless they are to be used in complete darkness.

Application software control of the viewing element timer will be required if the primary telecommunications device is to be built with multiple LC or LED real time motion capable viewing elements due to their far greater power consumption. More aggressive on and off timing of the displayed images on all of the screens will have to be addressed in order to keep the battery life within commercially acceptable values.

The primary telecommunications device and accompanying apparatus is a power intensive device, and to offer the user an acceptable amount of running time, in a preferred embodiment, a battery storage system 214 has been devised to encapsulate two internal batteries 214a, 214b instead of requiring the user to interrupt their use of the device to switch batteries. Battery switching always runs the risk of having potentially non-retrievable information from being lost from the display or from the memory. A dual internal battery arrangement; the batteries are drained individually and automatically switched internally through the use of electronic switching. The batteries are held in place using a folding door technique, whereby the rear section of the primary telecommunications main enclosure swings open on a hinge located on the bottom of the unit.

The electrical DC-DC converter power system is designed to incorporate a HOT-SWAP battery interface. The HOT-SWAP feature will allow either battery to be removed and exchanged while the system is still operating, unlike conventional communication systems where the battery can only be removed and exchanged after the device is unpowered. This feature allow the user to continuously use the device even if a battery should fail during the retrieval of non-replaceable information, insuring that such information will not be lost.

The gist of the detachable video core processor and viewing element is a high speed, low power CPU that interfaces thru conventional address, data, and control busses with the primary telecommunications device mainframe processor, but contains within it, its own isolated reprogrammable flash memory, applications memory, and a state of the art color or black and white E-INK liquid crystal active matrix display depending on the users purchasing requirements at the time the various options are acquired. Due to technological advances that are surely to occur in the future, viewing system density and resolution will change for the better over time; subsequently, any and all of the detachable video core processor and viewing elements can be exchanged for units that possess the latest and highest performance characteristics with regard to pixel density and memory storage, thereby keeping the primary communications current to the state of the art.

Each detachable video core processor and viewing element is equipped with a robust high density connector protected by a superstructure that encapsulates all of the on board circuit elements. The super-structure of the detachable video core processor and viewing element possesses a minimum of two detent elements, one or more on each side, to produce a positive holding detent force when it is inserted and stowed in the slots of the rear storage bay of the body of the primary telecommunications device. The user can, using their own discretion, remove from the storage bays any or all of the four detachable video core processor and viewing elements and deploy each one by inserting it into any one of the four available accessory connectors for them, one that appears on each peripheral side of the primary telecommunications device.

The accessory connectors for the primary telecommunications device are sheltered by spring loaded swinging protective door elements, each equipped with low durometer silicon rubber gasket that creates a reliable near air and liquid tight seal meant to keeps unwanted dust and debris out of the MACH main body when no detachable video core processor and viewing element is inserted into it. The protective door, opened when a detachable video core processor and viewing element is inserted into an accessory connector, trips a sensor on the primary device's mainframe circuit board to signal the main core processor that a new piece of hardware has been added to the overall electronic architecture. This allows the previously discussed software to recognize that there is an additional viewing element that needs to be fed with video information and that there are additional commands that must be performed, including the updating of the power supply control to inform that power processor there will be an additional current requirement from the batteries.

Referring to FIGS. 10 and 27-29, the detachable video core processor and viewing element containing the camera has an addition distinguishing feature that allows the user to identify the camera module from the other video processor modules so that it can be retrieved without delay in cases where quick access to video capturing or photographic capabilities is required.

The personal computer docking station with USB interface offers sufficient power to the primary communications device's internal battery charger through the primary device's USB port interface for the power controller. While the user is interfacing with the PC software in uploading or downloading data or video, the USB power source, in conjunction with the primary telecommunications device's internal power supply control, is charging the batteries. Specialized software running within the primary device's mainframe CPU monitors the charging percentage of the batteries and generates a video overlay on top of the GUI application running on the PC monitor to indicate to the user the status of the battery charging, and a visual and audible prompt to indicate that the charging is complete. The HOT-SWAP feature of the power supply controller will not affect the standard recharging scenarios of such communication system batteries, accomplishing the task with a customary USB port adapter from the docking station to the primary telecommunications device. The recharge circuitry will independently recharge one or both batteries depending on the status information derived from the internal battery voltage detectors in the battery management system that will determine the condition and recharge requirement of the batteries at any instant of time.

In a further preferred embodiment, one of the detachable video core processor modules is equipped with a multi-megapixel CCD image array and the other associated circuit components including, for example, an E-Ink viewing element. Since mega-pixel CCD elements contain large amounts or raw data, generated by the associated pixel accumulator that must be processed into a viable picture, processing all the data through the microprocessor, even at its fastest speed, would significantly slow down the throughput of the video or photo image.

The detachable and software reconfigurable video processing module allows for the viewing of multiple video images, one on main screen display and up to, for example, four additional video processing cards that can deployed from the main body of the primary telecommunications device, one of which is the camera module capable of inputting locally obtained pictures or full motion video. All of the detachable and software reconfigurable video processing modules, including the camera module, are capable of being detached from the primary telecommunications device and directly interfaced with an standard personal computer via the use of a USB capable docking station. The personal computer, running a specific application for this purpose, will allow a user to upload, store, manipulated and retrieve or download any video image or picture to and from the detachable video processing module for accessing at a later date, making the primary telecommunications device a video and picture archiving and trans-port device.

In order to eliminate any unnecessary delays for processing video information on the main display, the primary telecommunications device has been equipped with a DMA controller. The DMA controller will allow the video or photo image to be directly transferred into the video buffer memory for manipulation into .mpg or .jpg form to be viewed on the main screen. Once the DMA controller of the main core processor finishes the transfer of the image pixels, it will flag the microprocessor to begin the processing application to allow the video or photo to be viewed on the main viewing screen. A special real time viewer application will be running in parallel so that the main screen can view images as they are being photographed or video captured by the detachable video core processor module.

All of the detachable video processor modules are capable of storing application software in the core CPU memory for the purpose of running games of a very wide variety. Because each of the detachable video processor and viewing elements is a computer in its own right, they are equipped with all three elements of a computing device, a CPU, Memory, and I/O; making them capable of running applications separate and independent to that of the main core CPU of the primary telecommunications device. This powerful feature allows each of the video processor modules to run, suspend, or restart any gaming function taking place within its core processor at any time the user desires. Remote gaming, or gaming played over the telecommunications network while the primary telecommunications device is connected to any other individual on the system network, can be suspended where the players are, kept in memory, and reinitiated at a later date for completion. Chess games, for example, that cannot be completed at one session can be stored for completion at a later date; and the same may apply for any other two or more party game.

The primary telecommunications device has, in a preferred embodiment, a signup feature of the system architecture where by users define their interest in certain purchasable material offers advertisers a unique tool not seen before in such telecommunication devices. Working within the capabilities of the detachable video core processing modules, which have the capability to freeze and store viewed information, possess the ability to be sent redemption coupons for advertised merchandise by selection. When a user sees a product they wish to buy, they can respond over the telecommunications network and receive a redemption certificate for that item. By using the software configurable options of the video core processing module, the coupon information can be captured and stored for later retrieval using the personal computer interface docking station. Detaching the video core processor that contains the desired information from the primary telecommunications device and inserting it into the personal computer interface docking station will allow the PC to access the coupon, print out the coupon, and give the user the ability to avail himself or herself of the benefit.

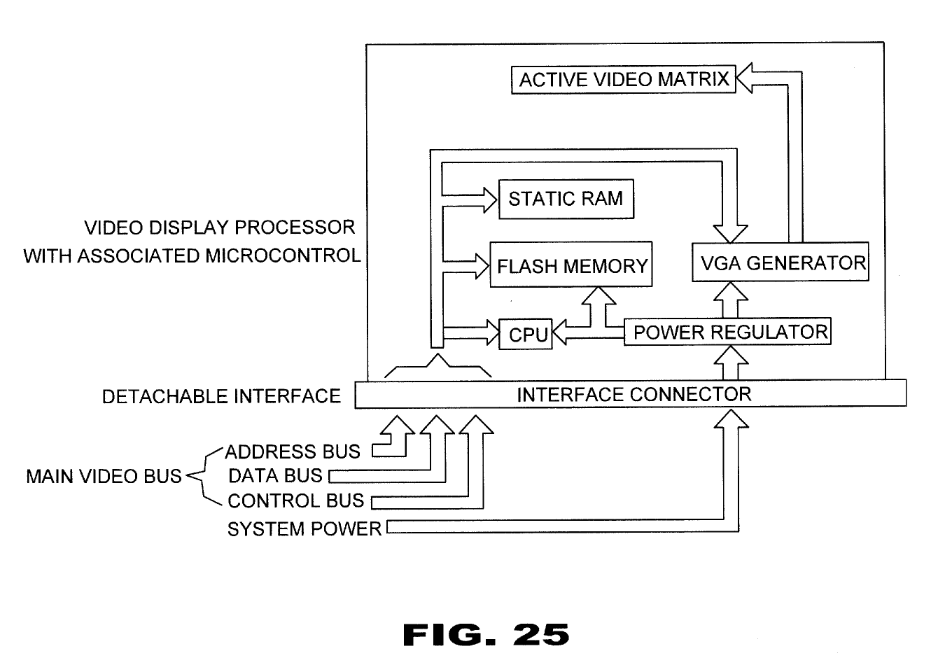

FIGS. 25-29 show the internal arrangement of a standard video core processing and viewing module. It can be seen that it possesses all the features of a stand-alone core based processor, capable of independent operation from the primary telecommunications mainframe. The address, data, and control bus elements are used to synchronize the operation of the module with that of the mainframe CPU.

Available software and sufficient flash memory within the detachable video core processor and viewing element modules allows that to be transportable audio storage for music not unlike the IPod®, in that a potential 8 GB of memory can store several hundred standard length songs. The personal computer docking station can be used, for example, in conjunction with numerous Internet connected purchasing sites, to download current popular songs, and upload them into any detachable video core processor and viewing element module for replay at any time the user desires. The very same process can be used to locate, purchase, and download currently released movies for uploading into the detachable video core processor and viewing element modules for viewing at any time, such as train, plane, or automobile travel without the use of telecommunications time. The GB capacity of the detachable video core processor and viewing element modules can store the full content of any major studio movie release.

While only several embodiments of the present invention have been shown and described, it will be obvious to those skilled in the art that many modifications may be made to the present invention without departing from the spirit and scope thereof.

What is claimed is:

1. An expandable multi-core telecommunication and video processing apparatus, comprising:
a primary telecommunications device having a microprocessor and a primary display;
at least one video core processor detachably connectable to said primary telecommunications device; and,
means for detachably connecting said at least one video core processor to said primary telecommunications device.

2. The expandable multi-core telecommunications and video processing system according to claim 1, wherein said primary telecommunications device includes a storage bay for retaining said at least one video core processor when said at least one video core processor is disconnected from said primary telecommunications device.

3. The expandable multi-core telecommunications and video processing system according to claim 2, wherein said storage bay is removably attachable to a rear surface of said primary telecommunications device.

4. The expandable multi-core telecommunications and video processing system according to claim 1, wherein said at least one video core processor is a plurality of video core processors.

5. The expandable multi-core telecommunications and video processing system according to claim 4, wherein said plurality of video core processors that are detachably connectable to said primary telecommunication device is four video core processors.

6. The expandable multi-core telecommunications and video processing system according to claim 5, wherein each video core processor of said four video core processors is detachably connectable to a top surface, a bottom surface and each of two opposing side surfaces of said primary telecommunications device.

7. The expandable multi-core telecommunications and video processing system according to claim 1, wherein said means for detachably connecting said at least one video core processor to said primary telecommunications device includes a plurality of magnetic contact pins located within a slot within said primary telecommunications device and a plug extending from said at least one video core processor.

8. The expandable multi-core telecommunications and video processing system according to claim 7, wherein said at least one video core processor is able to be detachably connected to said primary telecommunications device for facing in either a forward direction or a rearward direction by virtue of said plurality of magnetic contact pins located within said slot within said primary telecommunications device.

9. The expandable multi-core telecommunications and video processing system according to claim 1, wherein said means for detachably connecting said at least one video core processor to said primary telecommunications device includes a barrel hinge connected between said primary telecommunications device and said at least one video core processor for permitting a degree of rotation as between a plane of said primary telecommunications device and said at least one video core processor.

10. The expandable multi-core telecommunications and video processing system according to claim 9, wherein said at least one video core processor includes a receiving port located proximate to an opposing edge to an edge having said barrel hinge, said receiving port being capable of receiving an additional video core processor.

11. The expandable multi-core telecommunications and video processing system according to claim 10, further comprising an additional barrel hinge connected between said receiving port of said at least one video core processor and said additional video core processor.

12. The expandable multi-core telecommunications and video processing system according to claim 1, wherein said primary telecommunications device includes a USB port.

13. The expandable multi-core telecommunications and video processing system according to claim 12, further comprising a docking station capable of interfacing with said primary telecommunications device via said USB port and a connecting cable.

14. The expandable multi-core telecommunications and video processing system according to claim 1, further comprising a docking station having a USB port and capable of receiving data from said at least one video core processor via said USB port.

15. The expandable multi-core telecommunications and video processing system according to claim 14, wherein said docking station is connectable via a cable to a USB port of a personal computer.

16. The expandable multi-core telecommunications and video processing system according to claim 1, wherein said primary telecommunications device is a smart phone.

17. The expandable multi-core telecommunications and video processing system according to claim 1, wherein said primary telecommunications device includes means for allowing a user to securely grip said primary telecommunications device.

18. The expandable multi-core telecommunications and video processing system according to claim 17, wherein said means for allowing a user to securely grip said primary telecommunications device is a rotating, multi-finger slotted grip.

19. The expandable multi-core telecommunications and video processing system according to claim 1, wherein said at least one video core processor is a plurality of video core processor and all video core processors of said plurality of video core processors act independently of one another.

20. The expandable multi-core telecommunications and video processing system according to claim 1, wherein said at least one video core processor is a plurality of video core processor and at least two video core processors of said plurality of video core processors act in concert with one another.

21. The expandable multi-core telecommunications and video processing system according to claim 1, wherein said at least one video core processor is a plurality of video core processor and at least one video core processors of said plurality of video core processors act in concert with said primary display of said primary telecommunications device.

22. The expandable multi-core telecommunications and video processing system according to claim 1, wherein said primary display of said primary telecommunications device is a viewer touch screen interface.

23. The expandable multi-core telecommunications and video processing system according to claim 1, wherein said primary telecommunications device is a game controller.
